(19) United States
(12) Patent Application Publication
(10) Pub. No.: US 2017/0029549 A1
(43) Pub. Date: Feb. 2, 2017

(54) BIO-BASED POLYMER NANOPARTICLE AND COMPOSITE MATERIALS DERIVED THEREFROM

(71) Applicant: ECOSYNTHETIX LTD., Lansing, MI (US)

(72) Inventors: Steven BLOEMBERGEN, Okemos, MI (US); Jan VAN LEEUWEN, Burlington (CA); Niels Mathieu Barbara SMEETS, Courtice (CA); Vahid NOEEI ANCHEH, Hamilton (CA); Julien Francois Marie Antoine Philippe MESNAGER, Burlington (CA); Do Ik LEE, Midland, MI (US)

(21) Appl. No.: 15/291,598

(22) Filed: Oct. 12, 2016

Related U.S. Application Data
(63) Continuation-in-part of application No. PCT/US2015/025729, filed on Apr. 14, 2015.
(60) Provisional application No. 62/241,103, filed on Oct. 13, 2015.
(60) Provisional application No. 61/979,371, filed on Apr. 14, 2014.

(51) Int. Cl. C08F 290/10

(52) U.S. Cl. CPC C08F 290/10

(57) ABSTRACT

Methods of producing a latex, and the resulting latexes, are described herein. Bio-based colloidal particles are used in a free radical polymerization process. The particles may provide one or more of a seed particle, stabilizing agent, Pickering emulsifier, surfactant or co-monomer. Optionally, the particles (or biopolymer molecules such as starch in the particles) are functionalized, for example to provide double bonds or free radicals, prior to or while conducting a free radical polymerization reaction including the particles and a second compound which is a monomer. In another option, the particles are used in the presence of a functionalizing agent (capable for example of providing double bonds or free radicals on a biopolymer) in a free radical polymerization reaction. Optionally, the resulting latex may include particles of a mixed morphology including a bio-based phase. Methods of functionalizing bio-based particles and, in some cases, resultant particles (intermediate reaction products) are also described.

### RELATED APPLICATIONS

This application claims the benefit of U.S. Provisional Application Ser. No. 62/241,103, filed Oct. 13, 2015, and is a Continuation in Part of International Application Serial No. PCT/US2015/025729, filed Apr. 14, 2015, which claims the benefit of U.S. Provisional Application Ser. No. 61/979,371, filed Apr. 14, 2014. U.S. Application Ser. No. 62/241,103 and 61/979,371 and International Application Serial No. PCT/US2015/025729 are incorporated herein by reference.

### FIELD

This specification relates to bio-based materials, including polymer nanoparticles and reactive intermediates, and to methods of making them, and to latex compositions, as used for example as a binder in coated paper and paperboard manufacturing.

### BACKGROUND

U.S. Pat. No. 3,839,318, entitled Process for Preparation of Alkyl Glucosides and Alkyl Oligosaccharides, describes a process for the preparation of higher alkyl monosaccharides and oligosaccharides which are surface active.

U.S. Pat. No. 5,872,199, entitled Sugar Based Vinyl Monomers and Copolymers Useful in Repulpable Adhesives and Other Applications, and U.S. Pat. No. 6,242,593, entitled Environmentally Friendly Sugar-Based Vinyl Monomers Useful in Repulpable Adhesives and Other Applications, describe copolymers prepared from alkyl polyglycoside maleic acid esters and vinyl monomers which are biodegradable and repulpable. The copolymers are useful, for example, in adhesives.

U.S. Pat. No. 6,355,734, entitled Resin-Fortified Sugar-Based Vinyl Emulsion Copolymers and Methods of Preparing the Same, describes a method of preparing a resin-fortified polymer emulsion. In one embodiment, the method comprises polymerizing at least one monomer in the presence of a surfactant, an initiator, a resin and sugar-based vinyl monomer under emulsion polymerization reaction conditions effective for initiating polymerization, wherein an emulsion polymerization product is formed that comprises a sugar based vinyl monomer. An ink comprising a pigment and a resin-fortified polymer emulsion is also disclosed.

International Publication Number WO 2012/045159, entitled Use of Biobased Sugar Monomers in Vinyl Copolymers as Latex Binders and Compositions Thereon, describes sugar monomers used to provide comonomers for bio-synthetic hybrid paper binder systems having a controlled hydrophilic-hydrophobic balance.

International Publication Number WO 00/69916, entitled Biopolymer Nanoparticles, describes a process for producing biopolymer nanoparticles in which the biopolymer is plasticized using shear forces, a crosslinking agent being added during the processing. After the processing, the biopolymer can be dispersed in an aqueous medium to a concentration between 4 and 40 wt %. This results in starch nanoparticles that are characterized by an average particles size of less than 400 nm.

International Publication Number WO 2008/022127, entitled Process for Producing Biopolymer Nanoparticles, describes a process for producing biopolymer nanoparticles in which biopolymer feedstock and a plasticizer are fed to a feed zone of an extruder having a screw configuration such that the biopolymer feedstock is processed using shear forces in the extruder, and a crosslinker is added to the extruder downstream of the feed zone. The temperatures in an intermediate section of the extruder are preferably kept above 100 degrees C. The screw configuration may include two or more steam seal sections. Water may be added in a post reaction section located after a point in which the crosslinking reaction has been completed.

### INTRODUCTION

This specification describes, among other things, bio-based nanoparticles, dispersions of nanoparticles, and methods of making them. The term “bio-based” as used herein includes materials that are partially bio-based. The term “nanoparticles” as used herein is not limited to particles having a size of 100 nm or less but also includes larger particles, for example particles up to 1000 nm, and particles that are capable of forming a colloid or latex. Optionally, the resulting materials may be biodegradable. The term “preferable” or variants thereof indicates that something is preferred but optional. Words such as “may” or “might” are meant to include the possibility that a thing might, or might not, be present.

This specification also describes methods of producing a latex product, and the resulting latexes. In the method, bio-based colloidal particles are used in a free radical polymerization process. The particles may provide one or more of a seed particle, surfactant, stabilizing agent or co-monomer. The particles are preferably, but not necessarily, functionalized with double bonds or free radicals.

Optionally, the particles (or biopolymer molecules such as starch in the particles) are functionalized, for example to provide double bonds or free radicals, prior to or while conducting a free radical polymerization reaction including the particles and a co-monomer. In other options, the particles are used in the presence of a functionalizing agent (capable for example of providing double bonds or free radicals on a biopolymer) in a free radical polymerization reaction.

Optionally, the resulting latex may include particles of a mixed morphology including a bio-based phase.

Methods of functionalizing bio-based particles and, in some cases, resultant particles (intermediate reaction products) are also described.

Some nanoparticles described herein have at least two compounds, or a reaction product of them. At least the first compound is in part or entirely bio-based. The second compound is a monomer, oligomer, macromer or polymer containing at least one moiety or functional group not present in the first compound, for example a double bond. The nanoparticles may be made, for example, by a reactive extrusion process including the second compound, or by reaction with the second compound after forming the nanoparticles.

In some examples, nanoparticles are made with starch and one or more vinyl monomers. In one particular example, the vinyl monomer is alkyl polyglycoside (APG), a bio-based surfactant oligomer.

In other examples, nanoparticles are made with starch and one or more functionalized vinyl monomers. In one particular example, the functionalized vinyl monomer is maleated alkyl polyglycoside, a bio-based macromer.

In other examples, nanoparticles are made with starch and a synthetic polymer. In one particular example, the synthetic polymer is a maleated butadiene containing polymer.

In some processes, the nanoparticles are used with added functionalities, if any, provided before a polymerization reaction. These nanoparticles may be copolymerized or otherwise reacted with a monomer, for example to produce a latex binder, in a free radical copolymerization process including but not limited to emulsion and suspension copolymerization processes. In other processes, nanoparticles are mixed in water with one or more monomers, for example vinyl monomers, in the presence of a functionalizing agent. For example, Cerium (IV) ions may be used to generate free radicals onto the starch nanoparticles, which are used as grafting sites to initiate copolymerization with vinyl monomers.

A polymerization reaction may include monomers or crosslinkers that impart biodegradable linkages into the copolymer. In this case, the resulting latex particles may be biodegradable.

Some nanoparticles described herein comprise at least two compounds or a reaction product of at least two compounds. At least the first compound is bio-based. The second compound is a monomer, oligomer, macromer or polymer containing at least one moiety or functional group not present in the first compound. Preferably, the second compound also contains hydroxyl functional groups. Preferably, the first and second compounds are crosslinked together. The nanoparticles may be made, for example, by a reactive extrusion process in which the first and second compounds are added to an extruder with water, optionally with a plasticizer and, preferably, with a crosslinker. The nanoparticle becomes functionalized in the sense that the moiety or functional group of the second compound is present. However, the first compound is not necessarily functionalized itself.

Suitable second compounds include for example: bio-based materials; polyols or hydrolizable oligomeric or polymeric compounds having a functional group in addition to hydroxyl groups; compounds with double bond functional groups; acrylic or maleic anhydride comprising monomers, macromers or polymers; telechelic and other multi-functional polymerizable oligomers or polymers and, monomers, oligomers, macromers and polymers that are water soluble or dispersible at a temperature present in the process.

In one example of nanoparticles as described above, nanoparticles are made with a biopolymer such as starch and an oligomer such as alkyl polyglycoside (APG). The nanoparticles may be more readily dispersible than similar nanoparticles made without the oligomer. In another example of nanoparticles as described above, nanoparticles are made with a biopolymer such as starch and a macromer such as maleated alkyl polyglycoside (alternatively called an alkyl polyglycoside maleic acid ester). The functionalized nanoparticles contain double bonds and may be used as monomers, macromers, co-monomers or other building blocks themselves.

Bio-based nanoparticles as described herein, preferably functionalized with polymerizable double bonds or free radicals, may act for example as one or more of a monomer, seed particle, stabilizer, surfactant or Pickering emulsifier, optionally serving as a replacement of a fraction of the petro-based monomer in polymerization process, such as an emulsion polymerization process, suspension polymerization process or precipitation polymerization process, for the production of bio-synthetic hybrid latex particles. Optionally, the synthetic component may include a polymerizable compound that introduces a biobased raw material and/or a biodegradable linkage, such as ester or amide bonds, into the carbon-carbon chains of the main copolymer network structure, such that the latex particles as a whole are rendered biobased and/or biodegradable. Examples of such comonomers include, but are not limited to, acrylated or maleated APG, acrylated or maleated biodegradable oligomers of polymers, telechelic and other multi-functional polymerizable oligomers, macromers or polymers, acrylic acid, acrylic acid esters, methacrylic acid, methacrylic acid esters, maleic acid, maleic acid esters, itaconic acid, itaconic acid esters, ethylene glycol dimethacrylate, polyethylene glycol dimethacrylate, ethylene glycol diacrylate, polyethylene glycol diacrylate, propylene glycol dimethacrylate, polypropylene glycol dimethacrylate, propylene glycol diacrylate, polypropylene glycol diacrylate, N,N-methylenebisacrylamide and other ester or amide-containing multifunctional monomers.

A latex produced as described herein may be used, for example, as a binder in the paper industry to completely or partially replace a conventional petroleum based latex binder, including (but not limited to) common synthetic binders such as styrene butadiene latex (XSB), styrene acrylic (SA), poly vinyl acetate (PVAc) and poly vinyl acetate acrylics (PVAc-Acryl).

In at least some examples of nanoparticles described herein, nanoparticles are made with a biopolymer such as starch and chemically reacted with one or more optionally functionalized vinyl monomers. The vinyl monomers preferably contain multiple functionalities, including 1) those that are reactive with hydroxyls (or that can be reacted via another reactive compound onto hydroxyls) and 2) double bonds that may be used as monomers, macromers, co-monomers or other building blocks themselves. Examples of such functionalized vinyl monomers include, but are not limited to, glycidyl methacrylate, methacrylic anhydride, maleic anhydride, itaconic anhydride, allyl chloride, and hydroxyethyl acrylate and other functional monomers that can be reacted with epoxies, isocyanates and other multifunctional hydroxyl-reactive compounds or crosslinkers, and mixtures thereof. These bio-based nanoparticles, functionalized with polymerizable double bonds, may act for example as a monomer or seed particle or polymerizable surfactant or Pickering emulsifier, optionally serving as a replacement of a fraction of the petro-based monomer in polymerization process, as described above, for the production of bio-synthetic hybrid latex particles. Optionally, the synthetic component may include a polymerizable compound that introduces a biobased raw material and/or a biodegradable linkage, as described above. A dispersion of the nanoparticles may be used, for example, as a binder in the paper industry to completely or partially replace a conventional petroleum based latex binder, as described above.

In at least some examples, nanoparticles are made with a biopolymer such as starch and then mixed in water with one or more vinyl monomers. Examples of such vinyl monomers include, but are not limited to, bio-based and/or conventional petroleum-based vinyl monomers, or mixtures thereof, and may include but are not limited to acrylic acid, acrylic acid esters, methacrylic acid, methacrylic acid esters, maleic acid, maleic acid esters, itaconic acid, itaconic acid esters, styrene and styrene based monomers, butadiene, (meth)acrylic monomers, acrylonitrile, and vinyl acetate, amongst many other common and specialty vinyl comonomer varieties, or mixtures thereof. The vinyl monomers may be ethyl hexyl acrylate, butyl acrylate, ethyl acrylate, hydroxyethyl acrylate, hydroxyethyl methacrylate, lauryl acrylate, methyl methacrylate, and other acrylates or mixtures of different acrylate monomers, ethylene, 1,3-butadiene, styrene, vinyl chloride, vinylpyrrolidinone, and other vinyl monomers or mixtures thereof. Other suitable vinyl monomers include-those disclosed in Table II/1-11 in Polymer Handbook, J. Bandrup, 3rd Ed. John Wiley & Sons Inc., (1989). The nanoparticles contain double bonds inside, or outside, or in the proximity of the nanoparticle surface that are not chemically or physically bound, and may be used as monomers, macromers, co-monomers or other building blocks themselves. These bio-based nanoparticles may act for example as a monomer or seed particle or polymerizable surfactant or Pickering emulsifier, optionally serving as a replacement of a fraction of the petro-based monomer in polymerization process, as described above, for the production of bio-synthetic hybrid latex particles. Optionally, the synthetic component may include a polymerizable compound that introduces a biobased raw material and/or a biodegradable linkage, as described above. A dispersion of the nanoparticles may be used, for example, as a binder in the paper industry to completely or partially replace a conventional petroleum based latex binder, as described above.

In at least some examples, nanoparticles are made with a biopolymer such as starch and then mixed in water with one or more vinyl monomers in the presence of a functionalizing or grafting agent such as Cerium (IV) ions to generate free radicals onto the starch nanoparticles, which are used as grafting sites to initiate copolymerization with vinyl monomers. Examples of such vinyl monomers include, but are not limited to, bio-based and/or conventional petroleum-based vinyl monomers, or mixtures thereof, as described above. These bio-based nanoparticles may act for example as a monomer or seed particle or polymerizable surfactant or Pickering emulsifier, optionally serving as a replacement of a fraction of the petro-based monomer in polymerization process, as described above. Optionally, the synthetic component may include a polymerizable compound that introduces a biobased raw material and/or a biodegradable linkage, as described above. A dispersion of the nanoparticles may be used, for example, as a binder in the paper industry to completely or partially replace a conventional petroleum based latex binder, as described above.

In the examples of a maleated alkyl polyglycoside and some other functionalizing agents, the nanoparticles contain double bond moieties which facilitate copolymerization between the nanoparticles and other monomers such as vinyl monomers including but not limited to styrene, butadiene, (meth)acrylic monomers, acrylonitrile, and vinyl acetate, amongst many other common and specialty vinyl comonomer varieties.

Nanoparticles comprising bio-based material and a non-bio-based monomer may be made, for example, by a copolymerization process. The copolymerization process may be a free radical polymerization or copolymerization process. The process may be a dispersed phase polymerization such as emulsion polymerization, suspension polymerization or precipitation polymerization. The process may involve ambient pressure or medium to high pressure systems for handling gaseous comonomers such as butadiene and ethylene and the like, and including those reactors typical for standard ambient pressure acrylic, styrene-acrylic and vinyl acetate emulsion polymerization processes, to medium pressure (typically up to 1000 psi) tanks used, for example, for vinyl acetate ethylene (VAE) copolymer latex emulsions, to ultra-high pressure tubular reactors used for EVA, EAA copolymers. One preferred process is starve-fed emulsion copolymerization. Another process involves a precipitation polymerization process. The resulting product may be a latex having some characteristics like a conventional petro-based XSB, SA, PVAc, PVAc-Acryl and other latex polymer products, but with a material amount of bio-based content. The latex may be used, for example, as a binder in the coated paper and paperboard industry alone or in a mixture with biopolymer nanoparticles or a conventional latex binder. The latex may also be used in a similar fashion in many other applications where petro-latex products are used, including but not limited to paints and coatings, adhesives, wood products, plywood, OSB (Oriented Strand Board), particle board, MDF (Medium Density Fiberboard), textiles, non-wovens, foam products, carpet, construction & building products, insulation, etc. Optionally, a biodegradable comonomer such as maleated APG and/or ethylene glycol dimethacrylate may be included in the polymerization process to render the latex biodegradable.

Some nanoparticles comprise a biopolymer portion and a synthetic polymer portion. These portions may be arranged in various multiple phase structures such as a core-shell structure, with the biopolymer portion inside of the synthetic polymer portion, or an inverse core-shell structure, a mixed morphology, “current-bun” morphology, or controlled agglomerate morphology. In at least the core-shell structure, the core and the shell may be hydrophobic, amphiphilic or hydrophilic. Optionally, there may be a composite shell or other structures with more than two phases. The biopolymer portion of a nanoparticle may comprise at least two compounds or a reaction product of at least two compounds as described above. Alternatively, the biopolymer portion may be made without the second compound. The mixed morphology may be produced by a dispersed phase polymerization process, which includes but is not limited to emulsion polymerization (including micro- and mini-emulsion polymerization), suspension polymerization and precipitation polymerization. The synthetic polymer portion may be made biodegradable through the use of a biodegradable crosslinker such as maleated alkyl polyglycoside or another polymerizable compound that introduces a biodegradable linkage, as mentioned above.

In a method of making a nanoparticle, a biopolymer is added to the feed zone of an extruder. The extruder may contain a feed zone, a gelatinization zone, an optional reaction (or crosslinking) zone, and a post processing zone. A second compound is optionally added downstream of the feed zone, for example in the gelatinization zone or reaction zone, or it may be added at a later stage, before or during a polymerization step.

A latex made with nanoparticles described herein may be used, for example, as a paper coating binder in the paper industry, alone or in a mixture with biopolymer nanoparticles or a conventional latex binder. The latex may also be used in a similar fashion in many other applications where petro-latex products are used, including but not limited to paper and paperboard coating binders, paints, coatings, adhesives, wood products, textiles, non-wovens, foam products, carpet, construction, building products, and insulation.

### BRIEF DESCRIPTION OF THE FIGURES

FIG. 1 is a schematic representation of the concept of producing bio-synthetic hybrid latex polymer products illustrating the formation of a core/shell morphology.

FIG. 2 is a TEM image of a core-shell nanoparticle prepared from a biopolymer nanoparticle containing polymerizable double bonds per Example 2.

FIG. 3 is a TEM image of an inverse core-shell nanoparticle prepared from a biopolymer nanoparticle containing polymerizable double bonds per Example 3.

FIG. 4 is a TEM image of a mixed morphology nanoparticle prepared from a biopolymer nanoparticle containing polymerizable double bonds per Example 4.

FIG. 5 is a TEM image of a core-shell nanoparticle prepared from a biopolymer nanoparticle without polymerizable double bonds per Example 6.

FIG. 6 is a schematic representation of bio-based nanoparticles used in a paperboard coating comprising a base coat and a top coat layer. For the purpose of simplifying this schematic, binder particles in the coating composition are illustrated while pigment particles are not.

FIG. 7 shows the results for the Aerobic Biodegradation under Composting Conditions (ASTM D-5338) for acrylic copolymers coated on Kraft paper (paper subtracted).

FIG. 8 is a plot of the evolution of the latex solids as a function of the polymerization time in the presence of unmodified starch nanoparticles per Example 11.

FIG. 9 is a plot of the evolution of the latex solids as a function of the polymerization time in the presence of unmodified starch nanoparticles per Example 12.

FIG. 10 is a plot of the evolution of the latex solids as a function of the polymerization time in the absence of starch nanoparticles per Example 13.

FIG. 11 is a plot of the evolution of the latex solids as a function of the polymerization time in the presence of maleated APG modified starch nanoparticles per Example 14.

FIG. 12 is a plot of the evolution of the latex solids as a function of the polymerization time in the presence of maleated APG modified starch nanoparticles per Example 15.

FIG. 13 is a plot of the evolution of the latex solids as a function of the polymerization time in the presence of maleic anhydride modified starch nanoparticles per Example 16.

FIG. 14 is a plot of the evolution of the latex solids as a function of the polymerization time in the presence of glycidyl methacrylate modified starch nanoparticles per Example 17.

FIG. 15 is a plot of the evolution of the latex solids as a function of the polymerization time in the presence of maleic anhydride modified starch nanoparticles per Example 18.

FIG. 16 is a TEM image of a core-shell nanoparticle prepared from a biopolymer nanoparticle without polymerizable double bonds per Example 9.

### DETAILED DESCRIPTION

U.S. Pat. Nos. 3,839,318, 5,872,199, 6,242,593 and 6,355,734 and International Publication Numbers WO 2012/045159, WO 00/69916 and WO 2008/022127 are incorporated by reference. WIPO (PCT) application number US2015/025729, Bio-based Nanoparticle and Composite Materials Derived Therefrom, filed on Apr. 14, 2015, is incorporated by reference.

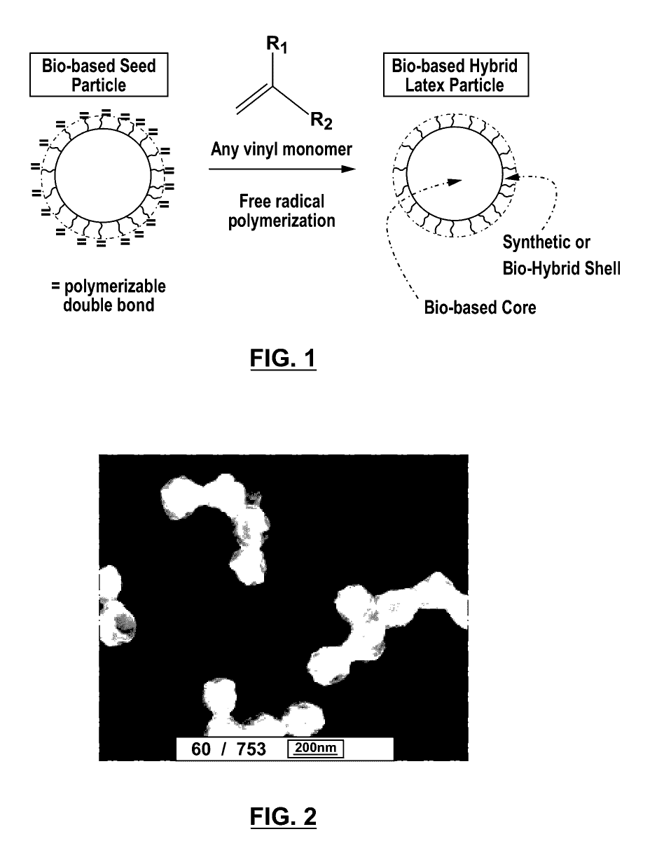

FIG. 1 is a schematic representation of a process for producing bio-synthetic hybrid latex polymer products. In the example shown, hybrid particles with core/shell morphology are formed as shown on the right hand side of the figure. In other cases, the latex product may have other configurations. In the example shown, a bio-based particle on the left hand side of the figure has been functionalized with polymerizable double bonds by reaction with a functionalizing agent prior to a polymerization reaction. Double bonds are shown chemically bound to the outside of the nanoparticle according to a theory related to some examples, but polymerizable moieties (i.e. free radicals or double bonds) may be inside, or outside, or in proximity of the nanoparticle surface, and may or may not be chemically or physically bound. A functionalizing agent may also be added during the polymerization reaction rather than in a prior reaction. In a further alternative, the particles are used in a non-functionalized (without double bonds or free radicals) state.

In the detailed description below, the preparation of some optional functionalizing agents and nanoparticles are described before describing the formation of latex products.

### Alkyl Polyglycoside (APG) and Maleated APG's

APG's are made from renewable resources, namely, sugars such as monosaccharides, oligosaccharides or polysaccharides. The most preferred sugar is dextrose (α-D-glucose), which is derived from corn or other starch crops.

To make an APG an aldose sugar, such as α-D-glucose, it is first reacted at the anomeric C1 carbon position with a primary alcohol or a mixture of primary alcohols (R—OH). The reaction is preferably conducted in the presence of an acid catalyst, such as concentrated sulfuric acid or para-toluene sulfonic acid or any other suitable acid. The excess alcohol may be removed by vacuum distillation or by other physical separation techniques, such as extraction, optionally after neutralization of the acid. The maleic acid esters of APG's have a polymerizable double bond and they are prepared by the reaction of an APG, maleic anhydride and optionally an alcohol.

The preparation of APG's is described in U.S. Pat. No. 3,839,318. Methods of making maleated APG's and various characteristics of them are described, for example in U.S. Pat. No. 5,872,199 and International Publication Number WO 2012/045159. A maleated APG is available commercially from EcoSynthetix Inc. under the trademark EcoMer. Parts of the description of methods for making APGs and maleated APGs in U.S. Pat. No. 5,872,199 will be repeated below for convenience.

The preparation of the APG's and the maleic acid esters can be illustrated as follows:

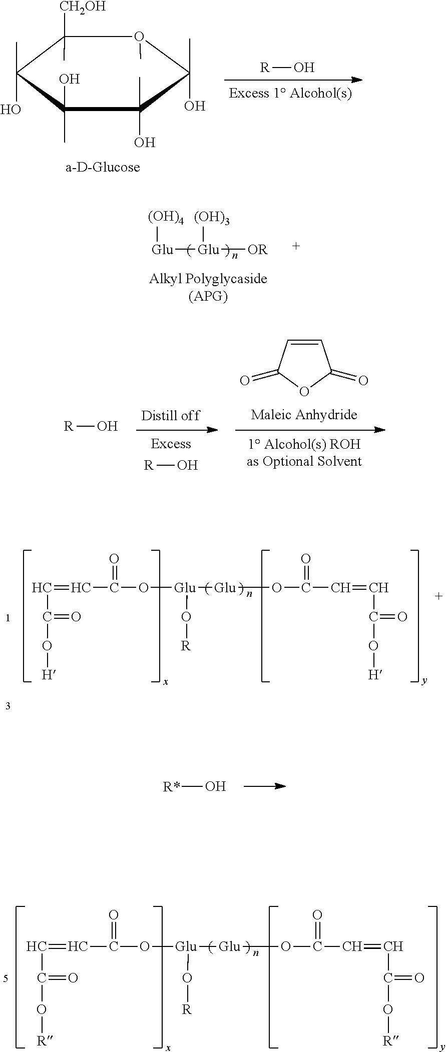

in which R″ is selected from the group consisting of a hydrogen and C1 to C30 alkyl groups or mixtures thereof, and all other symbols are as previously defined.

APG's for use in making maleated APGs may be those containing lower alkyl groups of four to six carbons (butyl to hexyl) or mixtures thereof, because such APG's are viscous liquids which can be readily reacted with maleic acid anhydride in the absence of a solvent.

Alternatively, APG's for use in making maleated APGs may be those containing higher alkyl groups of eight to sixteen carbons or higher, or mixtures thereof, because such alcohols are more readily available from bio-based sources such as from the saponification of coconut oil and other natural oils.

Whereas unmodified sugar is highly polar and insoluble in most organic solvents or monomers, the APG is a viscous liquid or solid which is soluble in the organic phase to facilitate reaction with maleic acid anhydride. Alternatively, above its melting point of about 55 degrees C., maleic acid anhydride is a liquid that is miscible with the APG. This avoids the use of a solvent that would contribute to VOC's. Optionally, other anhydrides such as succinic anhydride, itaconic anhydride, and different alkenyl succinic anhydrides can be used. In particular, itaconic anhydride is expected to have residual polymerizable double bonds after being reacted with APG. It is therefore expected that a reaction product of itaconic anhydride and APG could function as an alternative to maleated APG in the processes and compositions described in this specification.

In addition, common sugars such as α-D-glucose, or mono- and disaccharides, oligosaccharides and polysaccharides, generally contain appreciable levels of water (typically 8 to 12 weight %). In contrast, the APG's, which are prepared by the method described above, have a very low moisture content (typically less than 1 weight %). This is important because maleic acid anhydride is readily hydrolyzed by water to produce maleic acid as an undesired byproduct. Thus, an APG can be reacted with maleic anhydride at temperatures from about 55 degrees C. up to 120 degrees C. under anhydrous and homogeneous reaction conditions.

APG's having higher alkyl groups also can be used, in combination with a primary alcohol or a mixture of primary alcohols, having an alkyl group of preferably a C4 to C18 or a mixture thereof, or a dialkyl maleic ester, as a solvent for the APG during the maleation step.

When the APG is reacted with maleic anhydride at temperatures from about 55 degrees C. up to 120 degrees C. under anhydrous and homogeneous reaction conditions a primary alcohol or a mixture of primary alcohols (R′—OH), having an alkyl group of preferably a C3 to C8 or a mixture thereof, can be added during this step as a solvent for the APG. Other suitable solvents may also be used. When the alcohols R—OH and R′—OH are the same, partial removal of excess alcohol suffices in the reaction step to form the APG. The R′—OH alcohol is a reactive solvent which, upon reaction with maleic acid anhydride, provides an alkyl maleic acid monomer. Thus, this alcohol acts as a solvent during the maleation step, but is itself reacted quantitatively with maleic anhydride to provide a copolymerizable solvent/monomer in which the maleated APG is soluble. In place of the primary alcohol solvent, a dialkyl maleic ester can be used as a copolymerizable solvent, having alkyl groups of preferably a C1 to C18 alkyl or a mixture thereof, more preferably a C1 to C8 alkyl or a mixture thereof, and most preferably a C4 alkyl.

Following the maleation reaction, a primary alcohol (R″OH) or a mixture of primary alcohols, having an alkyl group of preferably C1 to C18 or a mixture thereof, more preferably C8 to C18 alkyl or a mixture thereof, and most preferably a C12 to C14 alkyl or a mixture thereof, can optionally be added to esterify any residual unreacted maleic anhydride, a portion or all of the free acid groups of the alkyl polyglycoside maleic acid and of the alkyl maleic acid, if present.

The alcohols for use in the above process are those hydroxyl-functional organic compounds capable of alkylating a saccharide at the “C1” position. The alcohols can be naturally occurring, synthetic or derived from natural sources.

The molar stoichiometry of maleic anhydride to APG is controlled to be more than one to afford incorporation of the sugar molecules into the main polymeric network structure.

The maleic acid esters of the APG's which are prepared by reacting an APG with maleic anhydride contain a polymerizable double bond. These sugar macromers are Generally Recognized As Safe (GRAS) and contain no Volatile Organic Compounds (VOCs).

### Manufacture of Nanoparticles

The manufacture of biopolymer nanoparticles is described, for example, in International Publication Number WO 00/69916 and International Publication Number WO 2008/022127. Other methods are known in the art for making biopolymer nanoparticles. The terms “nanoparticle” is sometimes used to refer to particles that are 100 nm and smaller. However, the term “nanoparticle” is also sometimes used to refer to larger particles, up to for example 1000 nm. In this specification the term “biopolymer nanoparticle” is used to refer to polymeric particles that (i) have an average particle size of about 1000 nm or less or (ii) form a polymer colloid or colloidal (latex) dispersion in water. Other terms such as “fine” (100 nm to 2500 nm) or “microparticle” (0.1 μm to 100 μm) are also used to refer to larger particles, but are not used herein because they often exclude smaller particles and can include particles too large to form a latex or other polymer colloid. Preferably, the biopolymer nanoparticles are regenerated particles, meaning that some structure of the native biopolymer (for example the crystalline structure of a native starch granule) is removed or changed in the manufacturing process.

Biopolymers, for example polysaccharides and proteins, and in principle any other biopolymer, and mixtures thereof, may be the biopolymer used in these processes. Any starch, for example waxy or dent corn starch, potato starch, tapioca starch, dextrin, dextran, starch ester, starch ether, carboxymethyl starch (CMS), and in principle any other starch or starch derivative, including cationic or anionic starch, and mixtures thereof, may be the biopolymer used in these processes. Any polysaccharide, cellulosic polymer or cellulose derivative, for example microcrystalline cellulose, carboxymethyl cellulose (CMC), any nanofibrillar cellulose (CNF), nanocrystalline cellulose (CNC), or cellulose ester, cellulose ether, chitin, chitosan, and in principle any other polysaccharide, cellulose or cellulose derivative, and mixtures thereof, may be the biopolymer used in these processes. Proteins, for example zein (corn protein) or soy protein, and in principle any other protein or modified protein, and mixtures thereof, may be the biopolymer used in these processes.

To make functionalized nanoparticles by reactive extrusion, methods such as those described above are modified to make nanoparticles with at least a first compound and a second compound. The first compound may comprise one or more compounds selected from the group consisting of polyols, biopolymers, and bio-based materials. For example, the first compound may be starch, or a mixture containing starch, for example 50% by weight of starch, with one or more other biopolymers, polysaccharides, proteins, polyols or bio-based materials. The second compound may comprise one or more compounds selected from the group of monomers, oligomers, macromers or polymers that are water soluble or dispersible at a temperature present in the process, bio-based materials, polyols or hydrolizable compounds having a functional group in addition to hydroxyl groups, compounds with double bond functional groups, maleic anhydride comprising polymers and butadiene containing polymers.

In another option, the second compound comprises one or more compounds selected from the group of oligomers, macromers or polymers that are bio-based, or petroleum- or natural gas-based materials, compounds having one or more chemical functionalities, including at least 1) double bonds that may be used for copolymerization, and optionally 2) functionalities that are reactive with hydroxyls (or that can be reacted via another reactive compound onto hydroxyls). Examples of such second polymers include, but are not limited to butadiene homo- and copolymers that contain double bonds in either their 1,4- or 1,2-butadiene repeat units, or both, such polymers including anionically- or free radically- or otherwise produced polybutadiene and polystyrene butadiene (SB and XSB) polymers, as well as maleated polybutadiene and polystyrene butadiene polymers. Preferred examples of second compounds include Ricon™ 130, 131, 134, 142, 144, 150, 152, 153, 130MA8, 130MA13, 130MA20, 131MA5, 131MA10, 131MA17, 131MA20, 184MA6, and 156MA17, and Ricobond™ 1031, 1731, 1756, and 2031, which are various non-maleanized and maleanized butadiene and styrene butadiene oligomers, macromers and polymers, having a range in molecular weight and maleic anhydride content, available commercially from Cray Valley. These second compounds are preferably reacted with starch or other biopolymers in a reactive extrusion process used to make biopolymer nanoparticles since they are viscous fluids or solids, which are otherwise difficult to react.

Optionally, the second compound is APG or maleated APG. The resulting material is a dispersion of nanoparticles. The addition of the second compound changes the properties of the first compound or functionalizes the first compound. The novel nanoparticles preferably contain at least 50% by weight of bio-based materials, or at least 75% by weight of bio-based materials, or at least 90% by weight of bio-based materials.

In one method, the first compound and the second compound are co-extruded with water and a crosslinker. The extruder is preferably a co-rotating twin screw extruder. The first compound is preferably provided at a concentration of at least 10 wt % or more preferably at a concentration of at least 40 wt % in an aqueous solvent, for example water or a mixture of water and alcohol or another hydroxylic liquid, to a feed zone of an extruder, or most preferably it is fed in neat or as-received form and then mixed in the extruder with an aqueous solvent, for example water or a mixture of water and alcohol or another hydroxylic liquid. A plasticizer, for example a polyol such as glycerol, may be added at a level of up to about 40% by weight of the first compound. Water also acts as a plasticizer and the total amount of water and other plasticizers may be 15-50%.

In an intermediate or gelatinization zone of the extruder, located downstream of the feed zone, the temperature is maintained between 60 and 200 degrees C., or between 100 and 140 degrees C. At least 100 J/g, or at least 250 J/g, of specific mechanical energy per gram of the first compound, is applied in the intermediate zone. The pressure in the intermediate zone may be between 5 and 150 bar. The first component is substantially gelatinized in the intermediate zone. The second compound is optionally added to the intermediate zone, or downstream of a barrel in which the first compound is substantially gelatinized. A crosslinker, if any, may be added in a reaction zone that follows, or overlaps with the end of the intermediate zone. The crosslinker may be added with or downstream of the second compound.

The crosslinker may be, for example, selected from the group consisting of dialdehydes, polyaldehydes, acid anhydrides, mixed anhydrides, glutaraldehyde, glyoxal, oxidized carbohydrates, periodate-oxidized carbohydrates, epichlorohydrin, di and tri-epichlorohydrin amine, epichlorohydrin adducts and other multifunctional epichlorohydrin, reaction products, epoxides, triphosphates, petroleum-based monomeric, oligomeric and polymeric crosslinkers, biopolymer crosslinkers, and divinyl sulphone. The crosslinking is preferably reversible, i.e. the crosslinks are partly or wholly cleaved during continued mechanical treatment. Suitable reversible crosslinkers include those which form chemical bonds at low water concentrations, which dissociate or hydrolyze in the presence of higher water concentrations. Examples of reversible crosslinkers are dialdehydes and polyaldehydes, which reversibly form hemiacetals, acid anhydrides and mixed anhydrides (e.g. succinic and acetic anhydride) and the like. Suitable dialdehydes and polyaldehydes are glutaraldehyde, glyoxal, periodate- or Tempo- or peroxide- or otherwise oxidized carbohydrates, and the like. Such crosslinkers may be used alone or as a mixture of reversible crosslinkers, or as a mixture of reversible and non-reversible crosslinkers. Thus, conventional crosslinkers such as epichlorohydrin and other epoxides, triphosphates, divinyl sulphone, can be used as non-reversible crosslinkers for polysaccharide biopolymers, while dialdehydes, thiol reagents and the like may be used for proteinaceous biopolymers. The crosslinking may be done with a combination of reversible and non-reversible crosslinkers. The crosslinking reaction may be acid- or base-catalyzed. The level of crosslinking agent can conveniently be between 0.1 and 10 weight % with respect to the biopolymer or other first compound. The crosslinking agent may be present at the start of the mechanical treatment, but in case of a non-pre-gelatinized biopolymer such as a starch with native starch granules, the crosslinking agent may be added later on, i.e. during the mechanical treatment in or after the intermediate zone.

In one example, starch is co-extruded with a sugar based compound such as maleated APG and water, and preferably with a crosslinker. Optionally, there may also be a plasticizer in addition to the water. The sugar based compound is preferably added downstream of where the starch has been converted into a thermoplastic melt phase. The crosslinker, if any, is preferably added downstream of where the sugar based compound is added.

In particular, the inventors have co-extruded starch with APG and maleated APG. Based on visual observation and viscosity data, starch-based nanoparticles made by co-extrusion with either APG or maleated APG disperse more readily than starch-based nanoparticles made according to the same formulation but without APG or maleated APG. The inventors have also observed that APG and maleated APG are stable in a reactive extrusion process for making starch based nanoparticles as described above. In particular, maleated APG does not homopolymerize in the extruder. Accordingly, the double bonds of maleated APG are still available for use in further reactions with the nanoparticles. The presence of double bonds in the nanoparticles post-extrusion was verified by proton NMR spectroscopy.

The maleated APG may be added in a range between about 0.1 to 10 parts per hundred parts of starch. The maleated APG is a viscous liquid but may be added to the extruder by heating it to above about 55 degrees C. and then conveying it with a pump designed to handle high viscosity materials, such as a standard hot-melt pump. Alternatively, the maleated APG could be first dissolved in water and added to the extruder as an aqueous solution. Preferably, water (optionally with glycerol or another plasticizer) and starch are added first to the extruder. After the starch has been plasticized by heat and shear forces in the extruder (i.e. downstream of where the starch is substantially plasticized in the extruder), the maleated APG is added to the extruder and mixed into the thermoplastic starch melt. Preferably, one or more crosslinkers are then added to the extruder (i.e. the one or more crosslinkers are added downstream of the maleated APG) and allowed to react.

### Other Methods of Functionalizing Nanoparticles

In another method, the first compound and the second compound are not co-extruded, but the second compound is added at a later stage, before or during a polymerization step.

In yet another method, nanoparticles are made with a biopolymer such as starch and chemically reacted with one or more functionalized vinyl monomers. The functionalized vinyl monomers contain multiple functionalities, including 1) those that are reactive with hydroxyls (or that can be reacted via another reactive compound onto hydroxyls) and 2) double bonds that may be used as monomers, macromers, co-monomers or other building blocks themselves. Examples of such functionalized vinyl monomers include, but are not limited to, glycidyl methacrylate, methacrylic anhydride, maleic anhydride, itaconic anhydride, allyl chloride, and hydroxyethyl acrylate and other functional monomers that can be reacted with epoxies, isocyanates and other multifunctional hydroxyl-reactive compounds or crosslinkers, and mixtures thereof. These bio-based nanoparticles, functionalized with polymerizable double bonds, may act for example as a monomer or seed particle or polymerizable surfactant or Pickering emulsifier, optionally serving as a replacement of a fraction of the petro-based monomer in polymerization process, such as an emulsion polymerization process or suspension polymerization process, for the production of bio-synthetic hybrid latex particles. Optionally, the synthetic component may include a polymerizable compound that introduces a biobased raw material and/or a biodegradable linkage, such as ester or amide bonds, into the carbon-carbon chains of the main copolymer network structure, such that the latex particles as a whole are rendered biobased and/or biodegradable. Examples of such comonomers include, but are not limited to, acrylated or maleated APG, acrylated or maleated biodegradable oligomers of polymers, telechelic and other multi-functional polymerizable oligomers, macromers or polymers, acrylic acid, acrylic acid esters, methacrylic acid, methacrylic acid esters, maleic acid, maleic acid esters, itaconic acid, itaconic acid esters, ethylene glycol dimethacrylate, polyethylene glycol dimethacrylate, ethylene glycol diacrylate, polyethylene glycol diacrylate, propylene glycol dimethacrylate, polypropylene glycol dimethacrylate, propylene glycol diacrylate, polypropylene glycol diacrylate, N,N-methylenebisacrylamide and other ester or amide-containing multifunctional monomers. A dispersion of the nanoparticles may be used, for example, as a binder in the paper industry to completely or partially replace a conventional petroleum based latex binder, including (but not limited to) common synthetic binders such as styrene butadiene latex (XSB), styrene acrylic (SA), poly vinyl acetate (PVAc) and poly vinyl acetate acrylics (PVAc-Acryl).

In yet another method, nanoparticles are made with a biopolymer such as starch and then mixed in water with one or more vinyl monomers. Examples of such vinyl monomers include, but are not limited to, bio-based and/or conventional petroleum-based vinyl monomers, or mixtures thereof, and may include but are not limited to acrylic acid, acrylic acid esters, methacrylic acid, methacrylic acid esters, maleic acid, maleic acid esters, itaconic acid, itaconic acid esters, styrene and styrene based monomers, butadiene, (meth)acrylic monomers, acrylonitrile, and vinyl acetate, amongst many other common and specialty vinyl comonomer varieties, or mixtures thereof. The vinyl monomers may be ethyl hexyl acrylate, butyl acrylate, ethyl acrylate, hydroxyethyl acrylate, hydroxyethyl methacrylate, lauryl acrylate, methyl methacrylate, and other acrylates or mixtures of different acrylate monomers, ethylene, 1,3-butadiene, styrene, vinyl chloride, vinylpyrrolidinone, and other vinyl monomers or mixtures thereof. Other suitable vinyl monomers include-those disclosed in Table II/1-11 in Polymer Handbook, J. Bandrup, 3rd Ed. John Wiley & Sons Inc., (1989). The nanoparticles contain double bonds inside, outside or in the proximity of the nanoparticle surface that are not chemically or physically bound, and may be used as monomers, macromers, co-monomers or other building blocks themselves. These bio-based nanoparticles may act for example as a monomer or seed particle or polymerizable surfactant or Pickering emulsifier, optionally serving as a replacement of a fraction of the petro-based monomer in polymerization process, as described above, for the production of bio-synthetic hybrid latex particles. Optionally, the synthetic component may include a polymerizable compound that introduces a biobased raw material and/or a biodegradable linkage, as described above. A dispersion of the nanoparticles may be used, for example, as a binder in the paper industry to completely or partially replace a conventional petroleum based latex binder, as described above.

In yet another method, nanoparticles are made with a biopolymer such as starch and then mixed in water with one or more vinyl monomers in the presence of Cerium (IV) ions to generate free radicals onto the starch nanoparticles, which are used as grafting sites to initiate copolymerization with vinyl monomers. Examples of such vinyl monomers include, but are not limited to, bio-based and/or conventional petroleum-based vinyl monomers, or mixtures thereof, as described above. These bio-based nanoparticles may act for example as an initiator or monomer or seed particle or polymerizable surfactant or Pickering emulsifier, optionally serving as a replacement of a fraction of the petro-based monomer in polymerization process, as described above, for the production of bio-synthetic hybrid latex particles. Optionally, the synthetic component may include a polymerizable compound that introduces a biobased raw material and/or a biodegradable linkage, as described above. A dispersion of the nanoparticles may be used, for example, as a binder in the paper industry to completely or partially replace a conventional petroleum based latex binder, as described above.

### Use of the Nanoparticles as a Macromer

Where the second compound is a monomer, oligomer, macromer or polymer, preferably carrying double bonds that are able to homopolymerize or copolymerize, the resulting nanoparticles are themselves rendered polymerizable compounds, which may be referred to as a monomer or macromers. Where the second compound is a monomer, oligomer, macromer or polymer, preferably carrying double bonds, that is inherently stable or stabilized so that it does not homopolymerize during its reaction with the first compound, the resulting nanoparticles are themselves polymerizable compounds, which may be referred to as a monomer or macromers. The terms monomer and macromer as used herein do not necessarily mean a compound with only one reactive site.

The bio-based nanoparticles, functionalized with polymerizable double bonds, may act as monomer or seed particles in a free radical or other copolymerization process, including for example as a replacement of a fraction of the petro-based monomer in a conventional polymerization process. The free radical copolymerization process may be any free radical polymerization or copolymerization process including, but not limited to emulsion polymerization, suspension polymerization or precipitation polymerization, and may include ambient pressure or medium to high pressure systems for handling gaseous comonomers such as butadiene and ethylene and the like, and including those reactors typical for standard ambient pressure acrylic, styrene-acrylic and vinyl acetate emulsion polymerization processes, to medium pressure (typically up to 1000 psi) tanks used, for example, for vinyl acetate ethylene (VAE) copolymer latex emulsions, to ultra-high pressure tubular reactors used for EVA, EAA copolymers. One preferred process is starve-fed emulsion copolymerization. Another preferred process involves a precipitation polymerization process. Without intending to be limited or bound by theory, one possible mechanism for the production of bio-synthetic hybrid latex particles having a biopolymer core and synthetic shell, or bio-synthetic hybrid shell, morphology, as one of multiple possible morphologies that can be attained, is illustrated in FIG. 1. FIG. 1 is a schematic drawing and is not intended to show all steps in the reaction or structural characteristics of the seed particle or hybrid particle, or to be to scale. For example, the seed particle may be made up of multiple sub-particles and so may have polymerizable double bonds also in its interior, or outside, or in proximity of the nanoparticle surface, and may or may not be chemically or physically bound. Alternatively or additionally, the seed particle may be much smaller than the hybrid particle, and the core of the hybrid particle may contain multiple seed particles. In another alternative, the core of the hybrid particle may have some of the vinyl monomer in it. In some reactions, including ones in which part of the vinyl monomer is present at the start of the reaction, an intermediate stage appears to exist. In the intermediate stage, bio-based material, which might or might not be small particles (relative to the final hybrid particle) or perhaps even individual molecules either of which might have previously formed one or more larger dispersed particles, surround or extend beyond a small synthetic particle. Without intending to be limited by theory, this intermediate stage might be analogous to a Pickering stabilization in which the bio-based material helps to stabilize the synthetic particle. As the polymerization progresses, the particle grows in size and develops a layer of synthetic material extending beyond the bio-based material. If there had been bio-based particles or molecules in the shell of the intermediate stage, they appear to have aggregate to form a core as synthetic monomer is added, thereby forming a hybrid particle with biopolymer-based (or at least biopolymer-containing) core and synthetic shell. Alternatively, the intermediate stage may optionally be preserved as the final morphology by stopping the addition of synthetic monomer such that a hybrid particle is produced with a synthetic (or bio-synthetic hybrid) core and a biopolymer-based shell.

In the example of a nanoparticle made with maleated APG, copolymers may be prepared by reacting the nanoparticles with other monomers, for example vinyl monomers, to produce novel hybrid nanoparticles. The novel hybrid nanoparticles can comprise copolymers of alkyl polyglycoside maleic acid esters and vinyl monomers as represented by the following formula:

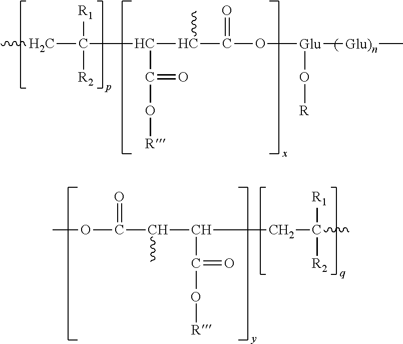

wherein Glu is a saccharide moiety which is derived from α-D-glucose (dextrose), fructose, mannose, galactose, talose, gulose, allose, altrose, idose, arabinose, xylose, lyxose, ribose, or mixtures thereof, or which can be derived by hydrolysis from the group consisting of starch, corn syrups or maltodextrins, maltose, sucrose, lactose, maltotriose, xylobiose, mellibiose, cellobiose, raffinose, stachiose, levoglucosan, and 1, 6-anhydroglucofuranose. R₁ and R₂ are substituent groups of a vinyl monomer or mixture of vinyl monomers, wherein said vinyl monomer or mixture of vinyl monomers is selected from the group consisting of vinyl acetate, ethyl hexyl acrylate, butyl acrylate, ethyl acrylate, hydroxyethyl acrylate, hydroxyethyl methacrylate, lauryl acrylate, methyl methacrylate, methacryclic acid, acrylic acid, and other acrylates or mixtures of different acrylate monomers, ethylene, 1,3-butadiene, styrene, vinyl chloride, vinylpyrrolidinone, and other vinyl monomers, or mixtures thereof, R is selected from the group consisting of a C1 to C30 alkyl or a mixture thereof, more preferably a C3 to C8 alkyl or a mixture thereof, R′″ is selected from the group consisting of a C1 to C30 alkyl or a mixture thereof, or a hydrogen, preferably a C8 to C18 alkyl or a mixture thereof, and most preferably a C12 to C14 alkyl or a mixture thereof; n is an integer ranging from 0 to 10, its average value ranging from 0.3 to 1; thus, <n+1>=1.3 to 2 corresponds to the average degree of oligomerization of the alkyl polyglycoside; x and y are integers ranging from 0 to 3 or from 0 to 4, where the maximum value of 3 or 4 for x and y equals the number of hydroxyls on the Glu moiety, but not both x and y are zero, and, p and q are integers ranging from 0 to 1000, but not both p and q are zero. The squiggly lines indicate continuing polymer chains.

Glu may be physically or chemically attached to a nanoparticle. For example, Glu may be all or part of the second compound in the manufacture of nanoparticles as described above. For example, Glu may be attached to a pre-existing biopolymer nanoparticle by a crosslinker.

The vinyl monomers may be conventional petroleum-based vinyl monomers and may include but are not limited to styrene and styrene based monomers, butadiene, (meth)acrylic monomers, acrylonitrile, and vinyl acetate, amongst many other common and specialty vinyl comonomer varieties. The vinyl monomers may be ethyl hexyl acrylate, butyl acrylate, ethyl acrylate, hydroxyethyl acrylate, hydroxyethyl methacrylate, lauryl acrylate, methyl methacrylate, methacrylic acid, acrylic acid, itaconic acid, and other acrylates or mixtures of different acrylate monomers, ethylene, 1,3-butadiene, styrene, vinyl chloride, vinylpyrrolidinone, and other vinyl monomers or mixtures thereof. Other suitable vinyl monomers include-those disclosed in Table II/1-11 in Polymer Handbook, J. Bandrup, 3rd Ed. John Wiley & Sons Inc., (1989).

Optionally, the use of nanoparticles made with alkyl polyglycoside maleic acid ester monomers produces random copolymers when reacted with conventional vinyl monomers. Various degrees of randomness in the copolymers can be attained by using a monomer pre-emulsion which is slowly added to the polymerizing mixture according to the so-called starve-fed copolymerization process.

The reaction of a maleic acid ester of an APG with a vinyl monomer to form a copolymer present in the nanoparticles may be illustrated as follows:

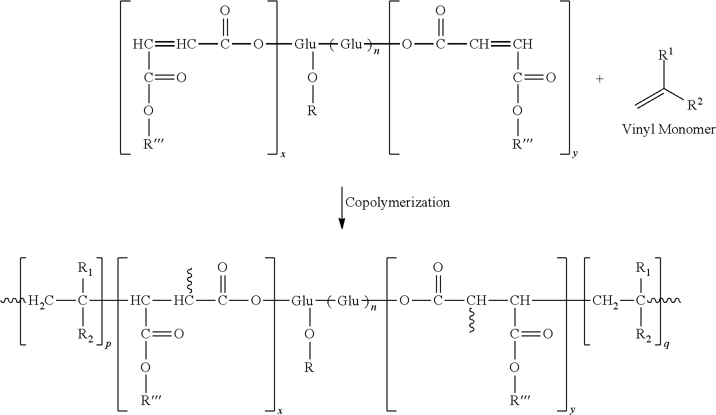

Similarly, in the example of a nanoparticle made with a biopolymer such as starch and then reacted with functional vinyl monomers, copolymers may be prepared by reacting the functionalized nanoparticles with other monomers, for example vinyl monomers, to produce further novel hybrid nanoparticles.

Similarly, in the example of a nanoparticle made with a biopolymer such as starch and then mixed in water with one or more vinyl monomers, copolymers may be prepared by reacting the nanoparticle-vinyl monomer mixture with other monomers, for example more of the same or other vinyl monomers, to produce further novel hybrid nanoparticles.

Without intending to be limited or bound by theory, a nanoparticle made from starch and maleated APG or other vinyl monomers, for example according to one of the examples below, may form a bio-based monomer or seed particle with polymerizable double bonds. Optionally, the seed particle may be used in the manner of a petro-based seed particle or otherwise serve as a replacement of a fraction of one or more petro-based monomers. Without intending to be limited or bound by theory, the inventors believe that the partially hydrophobic nature of the maleated APG causes the maleated APG to be concentrated near the surface of the nanoparticle when the nanoparticle is dispersed. However, this is not necessarily an essential characteristic of the nanoparticle. At least some of the double bonds of the maleated APG are available for further reactions regardless of the spatial distribution. The nanoparticles may be used as monomer or seed particles in a dispersed phase polymerization such as free radical emulsion polymerization. For example, the nanoparticles, considering their reactive double bonds, may be reacted with any vinyl monomer according the any of the examples described in U.S. Pat. No. 5,872,199 and International Publication Number WO 2012/045159. The resulting nanoparticle is a unique and novel hybrid or composite made up of the bio-based monomer or seed particle and the bio-synthetic copolymer.

A dispersion of the nanoparticles may be used, for example, as a coating binder in the paper industry to completely or partially replace a conventional petroleum based latex binder, including (but not limited to) common synthetic binders such as XSB, SA, PVAc and PVAc-Acryl. XSB latex is typically prepared by the emulsion copolymerization of styrene and butadiene monomers along with other minor comonomers including for example acrylic acid, methacrylic acid, itaconic acid and/or acrylonitrile. The X in XSB represents these other minor comonomers. Similarly, SA's are prepared from styrene and acrylic comonomers, and PVAc's are prepared by the polymerization of vinyl acetate monomer and may also include acrylate comonomers (PVAc-Acryl). For latex polymers adjusting the comonomer types and ratios affects the copolymer and final latex properties, such as for example paper coating and binder performance, paint binder or pressure sensitive adhesive (PSA) performance, etc. Carboxylation and other functionalities including acrylonitrile generally provide enhanced stability and binding power to synthetic latex binders. The nanoparticles may be used in the manner of a petro-based monomer or seed particle normally used in dispersed phase polymerization, such as free radical emulsion polymerization, to make these conventional materials. The nanoparticles thereby replace a fraction of the petro-based monomers normally used in creating a latex polymer. Thus, the functional nanoparticle provides a polymerizable bio-based chemical intermediate that may be used to introduce bio-content into petro-based latex polymers. This may be desirable simply to provide an alternative product, to mitigate the effects of increasing oil prices or oil price volatility, or from Nature's Carbon Cycle perspective (see Narayan, R. “The Promise of Biobased and Biodegradable Polymer Materials in Paper & Paperboard Products-Reducing Carbon Footprint and Improving Environmental Performance”, TAPPI (Technical association of the Pulp & Paper Industry) Conference Proceedings PaperCon09, 2009) to provide more environmentally effective or more sustainable materials.

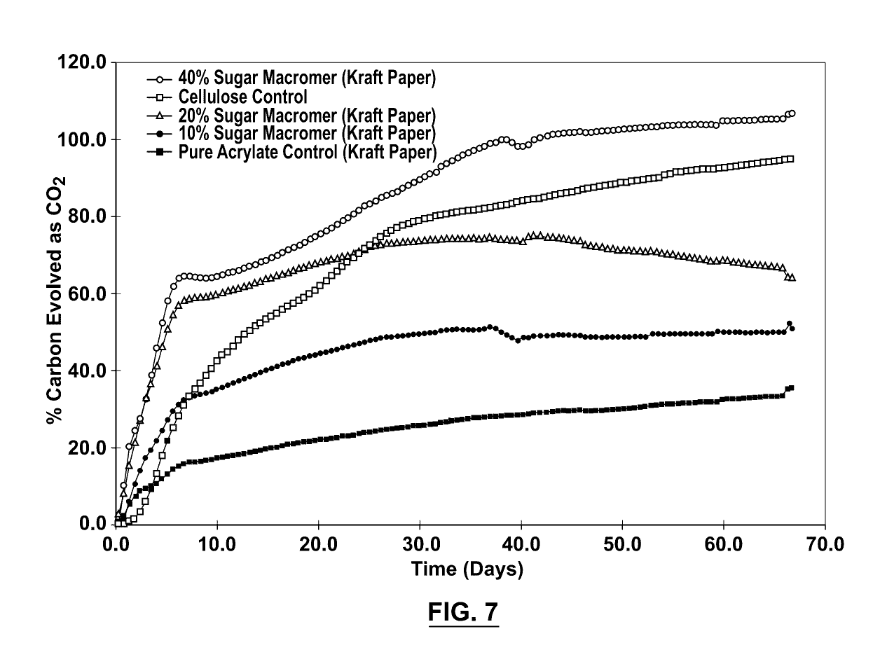

Optionally, the synthetic component may include a polymerizable compound that introduces a biodegradable linkage, such as ester or amide bonds, into the carbon-carbon chains of the main copolymer network structure. Without intending to be limited or bound by theory, the inventors believe that introduction of a heteroatom such as oxygen and nitrogen into the carbon-carbon backbone polymer chains of the main copolymer network structure produces linkages that can be biodegradable. At a sufficiently high level incorporated into the copolymer backbone structure, by way of the polymerizable compound which introduces the biodegradable linkage, the bio-synthetic hybrid latex particles as a whole may become fully biodegradable. Thus, the process of biodegradation either in nature, in a composting facility or in a sewage sludge operation, for example, will cleave those biodegradable linkages to produce low molecular weight carbon-carbon oligomers that in turn are biodegradable provided the molecular weight of these oligomers is sufficiently low so that these molecules can be assimilated by the microorganisms. The inventors have demonstrated this for acrylic copolymers in which up to 40 wt % EcoMer® (maleated APG or “Sugar Macromer”) was incorporated (see FIG. 7). Examples of such comonomers include, but are not limited to, acrylated or maleated APG, acrylated or maleated biodegradable oligomers, macromers of polymers, telechelic and other multi-functional polymerizable oligomers, macromers or polymers, ethylene glycol dimethacrylate, polyethylene glycol dimethacrylate, ethylene glycol diacrylate, polyethylene glycol diacrylate, propylene glycol dimethacrylate, polypropylene glycol dimethacrylate, propylene glycol diacrylate, polypropylene glycol diacrylate, N,N-methylenebisacrylamide and other amide-containing multifunctional monomers.

Without intending to be limited or bound by theory, the inventors believe that the bio-synthetic copolymer, in at least one embodiment of the invention, can form a shell around a bio-based core (referred to as a “core-shell” structure). However, a hybrid latex forming particle may exist in other configurations. Under specific conditions, different latex particle morphologies can be prepared. These morphologies might include either core-shell or inverse core-shell structures, or “current-bun” or other highly organized, or mixed, or random hybrid particle morphologies. Such specific conditions may include, but are not limited to, the selection and concentration of the surfactant, the alkyl tail length of the APG, the type of maleated APG, the overall vinyl comonomer composition, the ratio between the bio-based nanoparticle and vinyl monomer content, and the monomer feed strategy. These morphologies were identified and characterized by Transmission Electron Microscopy (TEM). To identify the location of the synthetic versus biopolymer components in the bio-synthetic latex particles, a staining technique was employed. As one example of a staining technique, ruthenium tetroxide (RuO₄) was used to provide contrast to the biopolymer component. RuO₄ was synthesized by reacting Ruthenium (IV) oxide hydrate (0.075 g) with sodium periodate (0.5 g) in distilled deionized water (12.5 mL) in an ice bath for 3-4 hours with continuous stirring. This 1% RuO₄ solution was used directly to stain the dried polymer latex samples approximately 15 min prior to imaging (see John S. Trent and co-workers, Macromolecules 1983, 16, 589-598, and the book: Linda C. Sawyer and co-workers, Polymer Microscopy 3rd Ed. 2008, Springer, for more information on RuO₄ staining in electron microscopy). This staining method was used with biopolymer nanoparticles made with starch and maleated APG and the biopolymer portion appears darker in the images.

Additional core-shell nanoparticles were also made by precipitation polymerization. This was done with starch nanoparticles made with and without APG or maleated APG as seed particles. Suitable polymers for this technique include but are not limited to vinyl monomers such as N-isopropylacrylamide (NIPAAm), N-isopropylmethacrylamide (NIPMAAm), N-diethylacrylamide (NDEAAm), diethylene glycol methacrylate (M(EO)₂MA), combinations of M(EO)₂MA and oligoethylene glycol methacrylates with average molecular weight 300, 500, 1100 and 2200 (OEGMA) and vinylcaprolactam (VCL). In images of these examples, the synthetic polymer portion was stained to appear darker by reacting the nanoparticle dispersion with uranyl acetate which stains the carboxylic acid groups copolymerized into the synthetic shell.

Without intending to be limited or bound by theory, the monomers described above can be copolymerized with any other vinyl monomer in a precipitation polymerization as long as the monomer is to some extent soluble in water.

Emulsion polymerizations can be performed in standard polymerization equipment, including a temperature controlled reactor vessel, mechanical agitation, and syringe or fluid metering pumps. Preferably, automated reactor equipment is used to provide superior control over the reactor temperature and addition rate of reactive ingredients. Dispersion of the nanoparticles and subsequent polymerization may be performed using standard pitched blade or anchor impellers, depending on the final latex viscosity. Mass-based addition of nanoparticles, monomers, initiator, and surfactant is preferred. Preferably, high shear agitation devices such as an Ultra-Turrax or Silverson Laboratory Mixer are used.

### EXAMPLES

The following examples are intended to further serve to illustrate the invention. They are not in any way intended to limit the scope of the invention.

### Example 1

### Manufacture of Nanoparticles

Nanoparticles were made with 100 parts waxy corn starch, 3 parts APG, 12.5 parts water, 10 parts glycerol and 2 parts glyoxal (see sample no. 1, Table 1). The starch, water and glycerol were added to the feed zone of an intermeshing self-wiping co-rotating twin screw extruder. The APG was added to an intermediate zone of the extruder where the starch was already fully gelatinized. The APG was added to the extruder as a 10% aqueous solution. The glyoxal was added in the intermediate zone after the APG. The extrudate was produced as foam through a die in the end zone of the extruder and ground into a fine powder product.

Other nanoparticles were made with 100 parts waxy corn starch, 3 parts maleated APG, 12.5 parts water, 0 parts glycerol and 3 parts glyoxal (see sample no. 2, Table 1). The starch and water were added to the feed zone of an intermeshing self-wiping co-rotating twin screw extruder. The maleated APG was added to an intermediate zone of the extruder where the starch was already fully gelatinized. The maleated APG is a viscous liquid and was added to the extruder by heating it to about 105 degrees C. and then conveying it using a hot-melt pump. The glyoxal was added in the intermediate zone after the maleated APG. The extrudate was produced as foam through a die in the end zone of the extruder.

Other nanoparticles were made with 100 parts waxy corn starch, 6 parts maleated APG, 12.5 parts water, 10 parts glycerol and 2 parts glyoxal (see sample no. 3, Table 1). The starch, water and glycerol were added to the feed zone of an intermeshing self-wiping co-rotating twin screw extruder. The maleated APG was added to an intermediate zone of the extruder where it is believed that the starch was already gelatinized. The maleated APG is a viscous liquid and was added to the extruder by heating it to about 110 degrees C. and then conveying it using a hot-melt pump. The glyoxal was added in the intermediate zone after the maleated APG. The extrudate was produced as foam through a die in an end zone of the extruder.

Other nanoparticles were made in a similar fashion as summarized in Table 1.

TABLE 1

| | Waxy Starch | Dent Starch | Crosslinker | Plastisizer | Second Compound | |
|---|---|---|---|---|---|---|
| Sample # | (pph) | (pph) | (pph) | (pph) | (type) | (pph) |
| 1 | 100 | 0 | 2 | 10 | C6-APG | 3 |
| 2 | 100 | 0 | 3 | 0 | Maleated C6-APG | 3 |
| 3 | 100 | 0 | 2 | 10 | Maleated C6-APG | 3 |
| 4 | 100 | 0 | 2 | 0 | — | 0 |
| 5 | 100 | 0 | 2 | 0 | Maleated C4-APG | 3 |
| 6 | 100 | 0 | 2 | 0 | Maleated C6-APG | 3 |
| 7 | 100 | 0 | 2 | 0 | Maleated C12-APG | 3 |
| 8 | 100 | 0 | 2 | 0 | Maleated C6-APG | 1 |
| 9 | 100 | 0 | 3 | 0 | Maleated C6-APG | 6 |
| 10 | 0 | 100 | 2 | 0 | Maleated C6-APG | 3 |

The extrudate from both the APG and the maleated APG containing samples was dried and the resulting powders (nanoparticles aggregates) re-dispersed on mixing in water. The APG-containing nanoparticles were observed to disperse more readily than similar nanoparticles made without APG.

The nanoparticles functionalized with maleated APG, which serve as a polymerizable biobased chemical intermediate in some examples below, take the form of an agglomerate powder in dry form with an average particle size of approximately 300 μm. These dry powder agglomerates can be readily dispersed in warm water (at 40 to 50 degrees C.) under continuous mechanical agitation. It is preferred to maintain a slightly basic pH of about 8.0 via the addition of a weak base such as 0.1 M sodium carbonate solution or its neat powder. Proper dispersion will result in a transparent light yellow to brown homogeneous suspension or dispersion (color depending on solids content and pH). The functionalized nanoparticles are dispersed under mechanical agitation up to a final solids content of about 40 w/w % in water at 50 degrees C. within 20 min.

### Example 2

### Sample Copolymerization Recipe-Bio-Based Core-Shell Latex Particles

Functionalized nanoparticles were further polymerized to produce core-shell latex particles by emulsion polymerisation under the following conditions:
a) Solids content=25 w/w %
b) Ratio of functionalized nanoparticles/acrylic monomer=20/80 w/w %
c) Surfactant concentration=0.2 w/w % to monomer
d) Initiator concentration=1.2 w/w % to monomer

Prior to polymerization, the functionalized nanoparticles are dispersed under mechanical agitation at 50 degrees C. as described above to prepare the seed dispersion. For example, 25 g of powder was dispersed in 325 mL water and the pH pre-adjusted using 0.1 M sodium bicarbonate solution. An aqueous solution (25.0 mL) of sodium bicarbonate (0.32 g) and the surfactant Aerosol™ EF-800 (0.25 g; CMC=0.03 w/w %) from CYTEC was added to the dispersion. The reactor contents were purged with nitrogen for 30 min and heated to 80 degrees C. In the meantime, the vinyl monomer methyl methacrylate (MMA, 100 g) and a solution of ammonium persulfate (1.5 g in 25 mL water) were purged. The initiator solution was added as one shot prior to the start of the monomer feed (80 mL/hr). After completion of the monomer feed (80 min) the polymerization was continued for another 60 min to ensure complete conversion of the monomer. The monomer conversion to polymer was followed via a standard gravimetric analysis and plotted against time, showing close to 100% conversion was attained in 90 mins. FIG. 2 shows a TEM micrograph of the latex for the final product after RuO₄ staining and illustrates the core/shell particle morphology. Note that in FIG. 2, which shows the particle morphology, the biopolymer nanoparticle core is dark and the acrylic copolymer shell is light. The particles were stained with RuO₄ to provide the contrast between acrylic & biopolymer components. The Intensity average particle diameter was measured via dynamic light scattering analysis using a Malvern Zetasizer Nano ZS at 25 degrees C. and an angle of 173°. Latex samples were diluted approx. 100× with distilled deionized water and placed in a glass cuvette (part number 83301-03) before measurement. All reported particle sizes are intensity-averages based on a minimum of 12 individual runs, showing a close to linear increase from ˜30 nm at close to time zero to ˜150 nm at ˜18% conversion, to ˜200 nm at ˜35% conversion, to ˜220 nm at ˜55% conversion, to ˜260 nm at close to 100% conversion. The final emulsion product was a pure white latex dispersion with a striking vibrancy. This in contrast to monomers polymerized in the presence of starch or dextrin solutions which are normally colored and not white, ranging from off-white to light yellow to dark brown depending on the starch content. This serves to further illustrate the unique and novel character of these bio-synthetic latexes.

### Example 3

### Sample Copolymerization Recipe-Inverse Core-Shell Latex Particles

Functionalized nanoparticles were further polymerized to produce inverse core-shell latex particles by emulsion polymerisation under the following conditions:
a) Solids content=25 w/w %
b) Ratio of functionalized nanoparticles/acrylic monomer=70/30 w/w %
c) Surfactant concentration=0.2 w/w % to monomer
d) Initiator concentration=1.2 w/w % to monomer

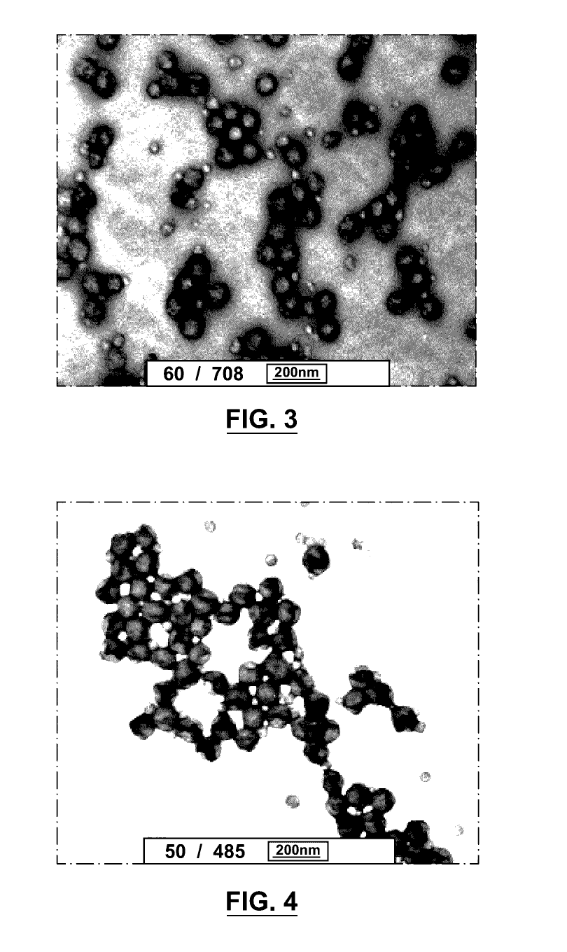

Prior to polymerization, the functionalized nanoparticles are dispersed under mechanical agitation at 50 degrees C. as described above to prepare the seed dispersion. For example, 87.5 g of powder was dispersed in 325 mL water and the pH pre-adjusted using 0.1 M sodium bicarbonate solution. An aqueous solution (25.0 mL) of sodium bicarbonate (0.35 g) and the surfactant Aerosol™ EF-800 (0.25 g) was added to the dispersion. The reactor contents were purged with nitrogen for 30 min and heated to 80 degrees C. In the meantime, the vinyl monomer methyl methacrylate (MMA, 37.5 g) and a solution of ammonium persulfate (1.5 g in 25 mL water) were purged. The initiator solution was added as one shot prior to the start of the monomer feed (80 mL/hr). After completion of the monomer feed (30 min) the polymerization was continued for another 60 min to ensure complete conversion of the monomer. The monomer conversion to polymer was followed via a standard gravimetric analysis and plotted against time. FIG. 3 shows a TEM micrograph of the latex for the final product after RuO₄ staining and illustrates the inverse core/shell particle morphology. Note that in FIG. 3, which shows the particle morphology, the biopolymer nanoparticle shell is dark and the acrylic copolymer core is light. The particles were stained with RuO₄ to provide the contrast between acrylic & biopolymer components. The final polymer had a particle size of ˜145 nm as determined by DLS.

### Example 4

### Sample Copolymerization Recipe-Mixed Morphology Latex Particles

Functionalized nanoparticles were further polymerized to produce mixed morphology latex particles by emulsion polymerisation under the following conditions:
a) Solids content=25 w/w %
b) Ratio of functionalized nanoparticles/acrylic monomer=40/60 w/w %
c) Surfactant concentration=0.2 w/w % to monomer
d) Initiator concentration=1.2 w/w % to monomer

Prior to polymerization, the functionalized nanoparticles are dispersed under mechanical agitation at 50 degrees C. as described above to prepare the seed dispersion. For example, 50 g of powder was dispersed in 325 mL water and the pH pre-adjusted using 0.1 M sodium bicarbonate solution. An aqueous solution (25.0 mL) of sodium bicarbonate (0.33 g) and the surfactant Aerosol™ EF-800 (0.25 g) was added to the dispersion. The reactor contents were purged with nitrogen for 30 min and heated to 80 degrees C. In the meantime, the vinyl monomer methyl methacrylate (MMA, 75 g) and a solution of ammonium persulfate (1.5 g in 25 mL water) were purged. The initiator solution was added as one shot prior to the start of the monomer feed (80 mL/hr). After completion of the monomer feed (60 min) the polymerization was continued for another 60 min to ensure complete conversion of the monomer. The monomer conversion to polymer was followed via a standard gravimetric analysis and plotted against time, showing close to 100% conversion was attained in 90 minutes. FIG. 4 shows a TEM micrograph of the latex for the final product after RuO₄ staining and illustrates a mixed morphology. Note that in FIG. 4, which shows the particle morphology, the biopolymer nanoparticle domains are dark and the acrylic copolymer domains are light. The particles were stained with RuO₄ to provide the contrast between acrylic & biopolymer components. The Intensity average particle diameter was measured via dynamic light scattering analysis, showing an increase from ˜30 nm at close to time zero to ˜260 nm at close to 100% conversion.

### Example 5

### Sample Copolymerization Recipe-Pressure Sensitive Adhesive (PSA) Formulation

Functionalized nanoparticles were further polymerized to produce mixed morphology latex particles by emulsion polymerisation under the following conditions:
a) Solids content=40 w/w %
b) Ratio of functionalized nanoparticles/acrylic monomer=15/85 w/w %
c) Surfactant concentration=2.0 w/w % to monomer
d) Initiator concentration=0.9 w/w % to monomer

Prior to the polymerization, the 30 g of functionalized nanoparticles are dispersed as described above to prepare the seed dispersion, and sodium bicarbonate (0.30 g) were added to 236 g water. A pre-emulsion was prepared by emulsifying butyl acrylate (BA, 194 g) and MMA (10 g) in 36 g water containing either sodium dodecyl sulphate (SDS) surfactant (4.0 g) or EF-800 surfactant (4.0 g). Prior to the pre-emulsion feed, a 1/3 aliquot of the aqueous solution of potassium persulfate (1.7 g in 30 g water) was added instantaneously to the dispersion. The pre-emulsion and initiator were fed continuously over 3.5 and 4.0 hours, respectively. Upon completion of the feeds, the reactor was agitated for an additional 60 min to ensure complete polymerization. The monomer conversion to polymer was followed via a standard gravimetric analysis and plotted against time, showing close to 100% conversion was attained in 250 mins. The Intensity average particle diameter was measured via dynamic light scattering analysis, showing for the EF-800 surfactant an initial steep increase from ˜30 nm at close to time zero to ˜160 nm at ˜8% conversion, followed by a close to linear increase to ˜260 nm at close to 100% conversion.

The monomer conversion to polymer was followed via a standard gravimetric analysis and plotted against time, showing close to 100% conversion was attained in 240 minutes. The Intensity average particle diameter was measured via dynamic light scattering analysis, showing for the SDS surfactant an initial steep increase from ˜30 nm at close to time zero to ˜160 nm at ˜15% conversion, followed by a close to linear increase to ˜225 nm at close to 100% conversion. The resulting latex had good film forming properties and formed homogeneous films with a translucent appearance. Conversely, blends of the seed particles and poly(butyl acrylate-co-methyl methacrylate) latex particles resulted in macroscopic phase separation and poor optical properties. The composite films swell in both water and organic solvents such as tetrahydrofuran, however, do not lose structural integrity. Depending on the choice and loading of surfactant peel strength of 17 N/m after 75 hours and tack of 250 N/m after 100 hours was measured at 25-30 degrees C. and 50-60% relative humidity.

### Example 6

### Sample Copolymerization Recipe-Bio-Based Core-Hydrophilic Shell Latex Particles

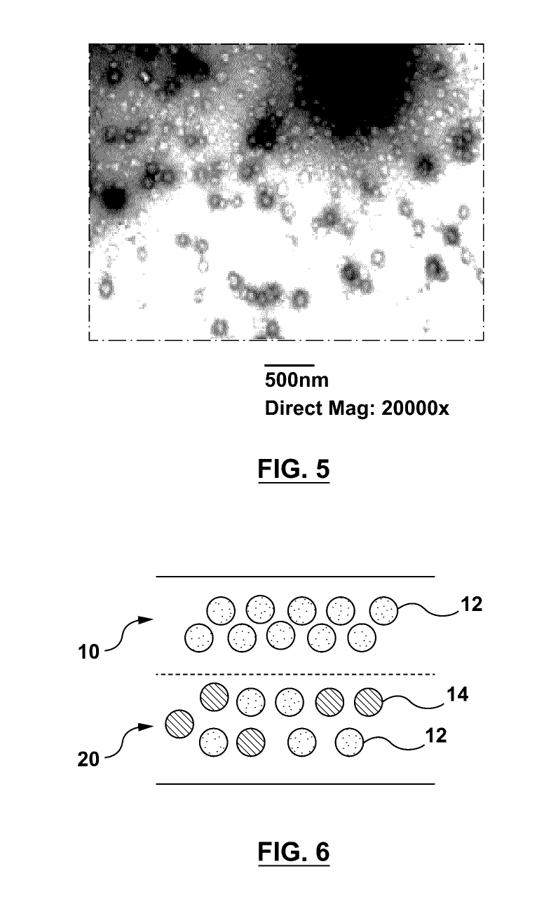

To an aqueous dispersion of crosslinked starch nanoparticles (5 g in 100 mL) which did not contain coextruded maleated APG, was added N-isopropylacrylamide (1 g), N,N-methylenebisacrylamide (0.1 g) and acrylic acid (0.05 g). The resulting dispersion was purged with nitrogen for at least 30 min. Subsequently, the solution was placed inside a pre-heated oil bath at 75 degrees C., maintaining inert atmosphere. When the solution reached the desired polymerization temperature of 70 degrees C., a solution of sodium persulfate (0.05 g in 2 mL water) was injected. The polymerization was continued for 8 hours after which the dispersion was cooled. FIG. 5 shows a TEM micrograph of the latex for the final product after uranyl acetate staining and illustrates the core/shell particle morphology. Note that in FIG. 5, which shows the particle morphology, the biopolymer nanoparticle core is light and the acrylamide copolymer shell is dark. The particles were stained with uranyl acetate to provide the contrast between acrylic & biopolymer components.

### Example 7

### Exemplary Use of Functional Bio-Based Nanoparticles and their Bio-Synthetic Hybrid Latex Products

Referring to FIG. 6, one use of the functional bio-based nanoparticles and their bio-synthetic hybrid latex products is illustrated. Currently, bio-based nanoparticles per the prior art, of for example International Publication Number WO 00/69916, are used to replace a portion of conventional XSB or SA latex binders in the pigmented pre-coat and top coat in a fine paper or paperboard coating process. In higher end applications, traditionally the pre-coat may have contained a minor portion of a conventional cooked coating starch cobinder, while the top coat typically only contained conventional petro-based XSB or SA latex. The bio-synthetic hybrid latex products described above may be used to replace some or all of the XSB or SA or petro-based other latex binder. The resulting coated paper and paperboard products have a pre-coat 20 comprising a pigmented coating that contains a mixture of conventional bio-based latex nanoparticles 14 and bio-synthetic hybrid nanoparticles 12 and a top coat 10 comprising a pigmented coating that contains primarily or entirely bio-synthetic hybrid nanoparticles 12 as the binder. In this way, a greater amount of conventional latex may be replaced by bio-based materials. Particles of the pigment have been omitted from FIG. 6 to focus on the binder particles. In a similar manner, bio-synthetic hybrid latex compositions can replace petroleum-based latex products used in applications related to any other latex polymer application, including but not limited to paints, coatings, adhesives, wood products (plywood, OSB, particle board, MDF, etc.), textiles, non-wovens, foam products, carpet, construction, building products, and insulation.

### Example 8

### Rendering the Synthetic Copolymer Component Biodegradable

Referring to FIG. 7, these results demonstrate that when the synthetic component includes a compound that introduces a biodegradable linkage into the carbon-carbon chains of the main copolymer network structure, the latex copolymer as a whole is rendered biodegradable. At a sufficiently high level of incorporation into the copolymer backbone structure, the copolymer as a whole becomes fully biodegradable. Thus, the process of biodegradation either in nature, in a composting facility or in a sewage sludge operation, will cleave those biodegradable linkages to produce low molecular weight carbon-carbon oligomers that in turn are biodegradable provided the molecular weight of these oligomers is sufficiently low so that these molecules can be assimilated by the microorganisms. This is demonstrated for acrylic copolymers in which up to 40 wt % EcoMer® (maleated APG or “Sugar Macromer”) was incorporated (see FIG. 7).

### Example 9

### Copolymerization of Starch Nanoparticles in a Precipitation Polymerization Process

0.32 grams of starch nanoparticles (EcoSphere™ 2202 produced by EcoSynthetix Inc.) were dispersed in water (0.5 w/w %), heated to 75 degrees Celsius and purged with nitrogen for 30 minutes to remove dissolved oxygen.

Once thoroughly purged, a solution of 3.2 grams N-isopropylacrylamide, 0.32 grams N,N′-methylenebisacrylamide and 0.16 grams acrylic acid in 10 mL water as well as a solution of 0.32 grams ammonium persulfate in 10 mL water were added simultaneously over a period of 4 hours at a rate of 1.875 mL/hr. Upon completion of the monomer and initiator feeds, the resulting latex was left to polymerize for a further 4 hours and cooled to 25 degrees Celsius.

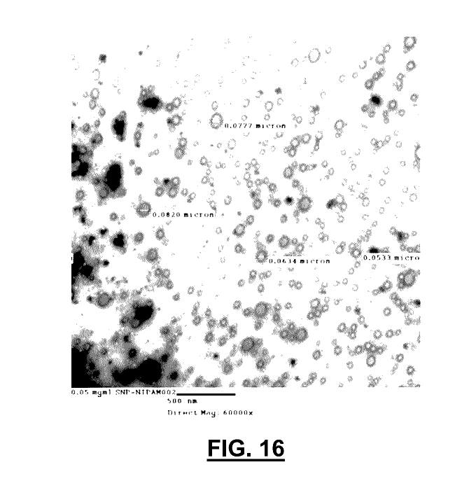

The resulting latex had a solids content of 2.6 w/w %. FIG. 16 shows a TEM micrograph of the latex for the final product after uranyl acetate staining and illustrates the core/shell particle morphology. Note that in FIG. 16, which shows the particle morphology, the biopolymer nanoparticle core is light and the acrylamide copolymer shell is dark. The particles were stained with uranyl acetate to provide the contrast between acrylic & biopolymer components.

### Example 10

### Preparation of Other Vinyl Functionalized Starch Nanoparticles

Other functionalized starch nanoparticles were produced by chemically modifying starch nanoparticles.

Vinyl functionalized starch nanoparticles were prepared by dispersing 100 parts starch nanoparticles in 400 parts water (approx. 20 w/w %). Once the starch nanoparticles were fully dispersed, the dispersion was heated to 50 degrees C. and the pH adjusted to 10.4 using a dilute sodium hydroxide solution (0.1 M). Subsequently, 1.3 parts glycidyl methacrylate were added to the reactor and the pH maintained at 10.4 for 20 hours. The resulting vinyl functionalized starch nanoparticle dispersion was purified using dialysis and the solids content adjusted to approx. 16 w/w %. The target degree of substitution was 0.015.

Other vinyl functionalized starch nanoparticles were prepared by dispersing 100 parts starch nanoparticles in 400 parts water (approx. 20 w/w %). Once the starch nanoparticles were fully dispersed, 1.4 parts of methacrylic anhydride were added dropwise to the dispersion over 1 hour. During addition of the methacrylic anhydride, the pH was maintained at 8.5 through the addition of a 2 w/w % sodium hydroxide solution in water. The resulting vinyl functionalized starch nanoparticle dispersion was purified using dialysis and the solids content adjusted to approx. 16 w/w %. The target degree of substitution was 0.015. Other vinyl functionalized starch nanoparticles were prepared by drying the nanoparticles in an oven at 60 degrees C. for 4 hours to remove excess moisture. Subsequently, 100 parts of the dried starch nanoparticles were thoroughly mixed with 0.9 parts of maleic anhydride (MAn). The dry mixture was heated to 90 degrees C. for 3-4 hours with occasional agitation. The resulting vinyl functionalized starch nanoparticles were used without any further purification. The target degree of substitution was 0.015.

In the examples provided below, all polymerizations are performed in a 1 L Mettler Toledo OptiMax automated lab reactor equipped with an anchor or pitched blade impeller, temperature and pH probe, and dosing units.

Solids contents and monomer conversion were measured using a CEM Smart System 5 microwave moisture analyzer (CEM) set to 140 degrees C. to ensure complete evaporation of the monomer.

Viscosity was measured with a Brookfield viscometer using spindle #2 or #3 at 100 rpm.

The whiteness (VV) of the latex is expressed as an offset in percentage points from pure white according to the equation: W=SQRT((100−L)̂2+â2+b̂2). The Hunterlab colour scale parameters L (light vs. dark), a (red vs. green) and b (yellow vs. blue) are measured using a Hunterlab Spectrophotometer.

### Example 11

### Copolymerization of Unmodified Starch Nanoparticles in an Emulsion Polymerization Process

50 grams of cross-linked waxy starch nanoparticles (Ecosphere™ 2202 produced by EcoSynthetix Inc.) were dispersed in water (approx. 16 w/w %) and heated to 60 degrees Celsius. The dispersion was then purged with nitrogen for 30 minutes to remove dissolved oxygen. 2.2 grams of itaconic acid was added to the reactor followed by 8 mL of an aqueous ammonium persulfate solution (10 w/v %) to start the polymerization.

A monomer pre-emulsion, consisting of 62 grams distilled deionized water, 11.7 grams Aerosol™ EF800 (Cytec Industries), 157 grams methyl methacrylate, 78 grams butyl acrylate, and 2.2 grams acrylic acid, was fed continuously for 100 minutes at a rate of 1.14 g/min. Simultaneously, 15 mL of an aqueous ammonium persulfate solution (10 w/v %) was added continuously for 130 minutes at a rate of 0.06 mL/min. Post-polymerization was carried out for 30 minutes and the latex cooled to 25 degrees Celsius, filtered to remove any minor fraction of coagulum formed, and drained from the reactor.

The resulting latex had a solids content of 31.3 w/w %, a pH of 3-4 and a Brookfield viscosity of 292 cP at 24 degrees Celsius. The biocontent of the latex equals approximately 35 w/w %.

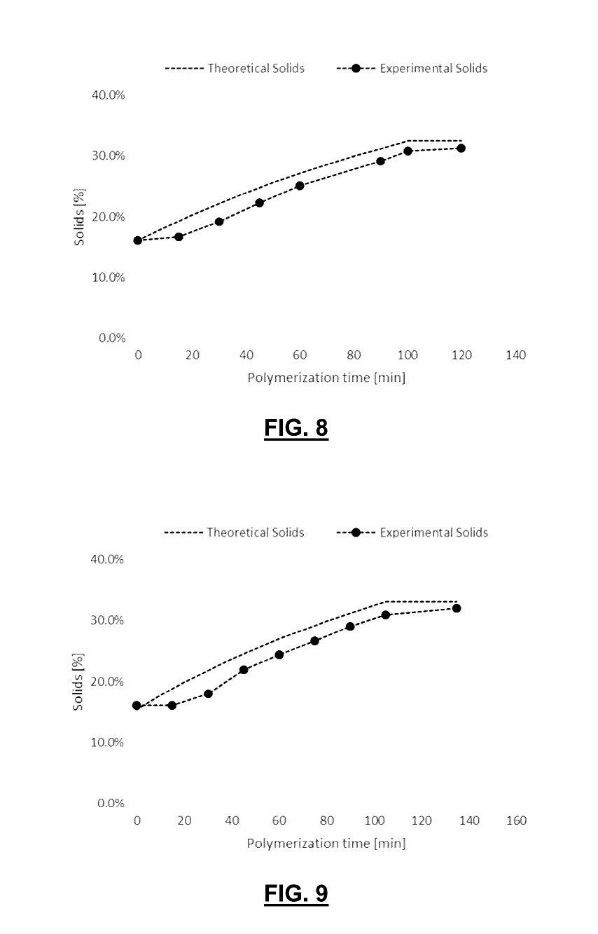

The conversion-solids curve (FIG. 8) demonstrates that the emulsion polymerization proceeded under starved-fed conditions.

### Example 12

### Copolymerization of Unmodified Starch Nanoparticles in an Emulsion Polymerization Process

50 grams of cross-linked waxy corn starch nanoparticles (Ecosphere™ 2202 produced by EcoSynthetix Inc.) were dispersed in water (approx. 16 w/w %) and heated to 60 degrees Celsius and purged with nitrogen for 30 minutes to remove dissolved oxygen. Subsequently, 8 mL of an aqueous ammonium persulfate solution (10 w/v %) was added to start the polymerization.

A monomer pre-emulsion, consisting of 62 grams distilled deionized water, 11.7 grams Aerosol™ EF-800 (Cytec Industries), 157 grams methyl methacrylate and 78 grams butyl acrylate was fed continuously for 100 minutes at a rate of 1.14 g/min. Simultaneously, 15 mL of an aqueous ammonium persulfate solution (10 w/v %) was added continuously for 130 minutes at a rate of 0.06 mL/min. Post-polymerization was carried out for 30 minutes and the latex cooled to 25 degrees Celsius, filtered to remove any minor fraction of coagulum formed, and drained from the reactor.

The conversion-solids curve (FIG. 9) demonstrates that the emulsion polymerization proceeded under starved-fed conditions.

The resulting latex had a solids content of 32 w/w %, a pH 7-8 and a Brookfield viscosity of 187 cP at 24 degrees Celsius. The biocontent of the latex equals approximately 33 w/w %. The whiteness offset of the latex 11%. The dispersion was followed with time and remained stable.

Examples 11 and 12 demonstrate that starch nanoparticles can be used in an emulsion polymerization process to obtain stable hybrid latex products.

The whiteness offset of the latexes produced in examples 11 and 12 (11-14%) are similar to the whiteness offset of a commercially available all synthetic latexes (e.g. ProStar 5404, Trinseo, 15.8% whiteness offset at 51.1 w/w % solid; Acronal S504, BASF, 19.3% whiteness offset at 49.8 w/w % solids and 10.9% whiteness offset at 31.2 w/w % solids).

The whiteness offset of the latexes produced in examples 11 and 12 (11-14%) outperforms a simple blend of a synthetic latex and starch nanoparticles (e.g. Acronal S504 (BASF) with EcoSphere™ 2202 (EcoSynthetix Inc.) at an 80/20 w/w % ratio and 40 w/w % solids yields a whiteness off-set of 16.7%). Additionally, the colloidal stability of such blends is easily compromised, whereas the copolymerized formulations maintain colloidal stability for at least 3 months.

### Example 13

### Emulsion Polymerization Process without the Use of Starch Nanoparticles

Water (200 grams) was heated to 60 degrees Celsius and purged with nitrogen for 30 minutes to remove dissolved oxygen. Subsequently, 8 mL of an aqueous ammonium persulfate solution (10 w/v %) was added to start the polymerization.

A monomer pre-emulsion, consisting of 62 grams distilled deionized water, 11.7 grams Aerosol™ EF-800 (Cytec Industries), 160 grams methyl methacrylate, 83 grams butyl acrylate, was fed continuously for 210 minutes at a rate of 1.12 g/min. Simultaneously, 15 mL of an aqueous ammonium persulfate solution (10 w/v %) was added continuously for 240 minutes at a rate of 0.06 mL/min. Post-polymerization was carried out for 30 minutes and the latex cooled to 25 degrees Celsius, filtered to remove any minor fraction of coagulum formed, and drained from the reactor.

The solids versus time curve shows an inhibition period and accumulation of monomer during the first 60 minutes of polymerization. The polymerization proceeds partially under monomer-flooded and partially in monomer-starved conditions.

The resulting latex had a solids content of 42.6 w/w %, a pH of 8-9 and a Brookfield viscosity of 28.4 cP at 25 degrees Celsius. The biocontent of the latex equals 0 w/w %. The whiteness offset of the latex is 8.4%. The dispersion was followed with time and remained stable.

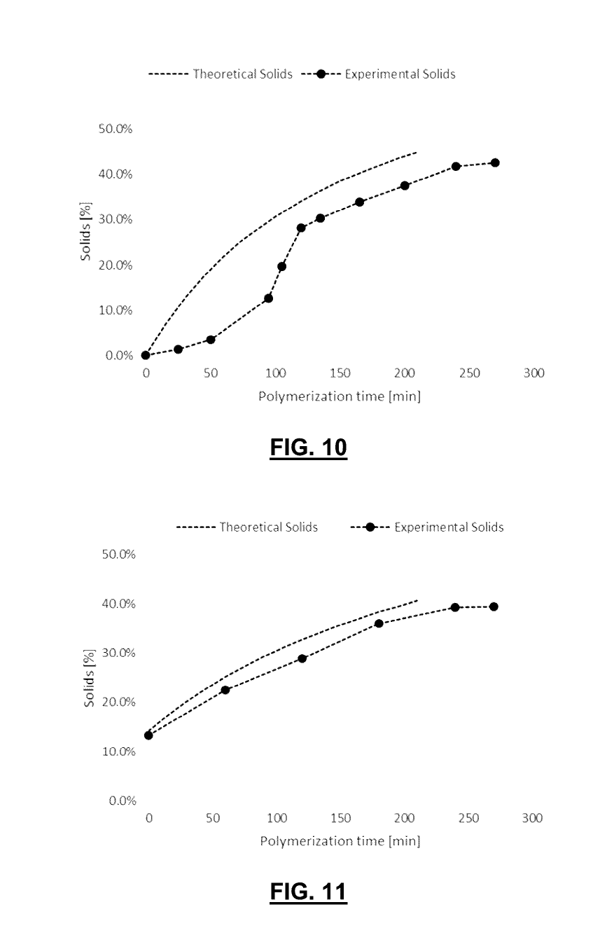

Comparison of the results in FIGS. 8 and 9 versus those in FIG. 10 demonstrates the starch nanoparticles accelerate the polymerization reaction in the initial stage of the process. Without intending to be limited or bound by theory, this demonstrates that the starch nanoparticles not only act as a seed particle and active comonomer in the polymerization, but also unexpectedly and beneficially as (reactive) surfactant or Pickering stabilizers during the initial stages of the emulsion polymerization.

### Example 14

### Copolymerization of Maleated APG Functionalized Starch Nanoparticles in an Emulsion Polymerization Process

50 grams of starch nanoparticles produced according to Example 1, sample 2, were dispersed in water (approx. 16 w/w %) and heated to 60 degrees Celsius. The dispersion was then purged with nitrogen for 30 minutes to remove dissolved oxygen. Subsequently, 8 mL of an aqueous ammonium persulfate solution (10 w/v %) was added to start the polymerization.

A monomer pre-emulsion, consisting of 58 grams distilled deionized water, 10.7 grams Aerosol™ EF-800 (Cytec Industries), 149 grams methyl methacrylate, 77 grams butyl acrylate, was fed continuously for 210 minutes at a rate of 1.14 g/min. Simultaneously, 15 mL of an aqueous ammonium persulfate solution (10 w/v %) was added continuously for 240 minutes at a rate of 0.06 mL/min. Post-polymerization was carried out for 30 minutes and the latex cooled to 25 degrees Celsius, filtered to remove any minor fraction of coagulum formed, and drained from the reactor.

The resulting latex had a solids content of 41.3 w/w %, a pH of 4-5 and a Brookfield viscosity of 114 cP at 25 degrees Celsius. The biocontent of the latex equals approximately 20 w/w %. The whiteness offset of the latex is 11.6%. The dispersion was followed with time and remained stable.

The conversion-solids curve (FIG. 11) demonstrates that the emulsion polymerization proceeded under starved-fed conditions.

Comparison of the results in FIGS. 8 to 10 with those in FIG. 11 demonstrates that the maleated APG modified starch nanoparticles accelerate the polymerization reaction in the initial stage of the process just as the starch nanoparticles.

### Example 15

### Copolymerization of Maleated APG Functionalized Starch Nanoparticles in an Emulsion Polymerization Process

50 grams of starch nanoparticles produced according to Example 1, sample 2, were dispersed in water (approx. 16 w/w %) and heated to 60 degrees Celsius. The dispersion was then purged with nitrogen for 30 minutes to remove dissolved oxygen. Subsequently, 1.1 grams itaconic acid and 8 mL of an aqueous ammonium persulfate solution (10 w/v %) was added to start the polymerization.

A monomer pre-emulsion, consisting of 62 grams distilled deionized water, 11.7 grams Aerosol™ EF-800 (Cytec Industries), 12 grams methyl methacrylate, 222 grams butyl acrylate, and 2.2 grams acrylic acid was fed continuously for 210 minutes at a rate of 1.14 g/min. Simultaneously, 15 mL of an aqueous ammonium persulfate solution (10 w/v %) was added continuously for 240 minutes at a rate of 0.06 mL/min. Post-polymerization was carried out for 30 minutes, the latex cooled to 25 degrees Celsius, filtered to remove any minor fraction of coagulum formed, and drained from the reactor.

The resulting latex had a solids content of 39.7 w/w %, a pH of 4-5 and a Brookfield viscosity of 97 cP at 25 degrees Celsius. The biocontent of the latex equals approximately 20 w/w %. The whiteness offset of the latex is 12.6%. The dispersion was followed with time and remained stable.

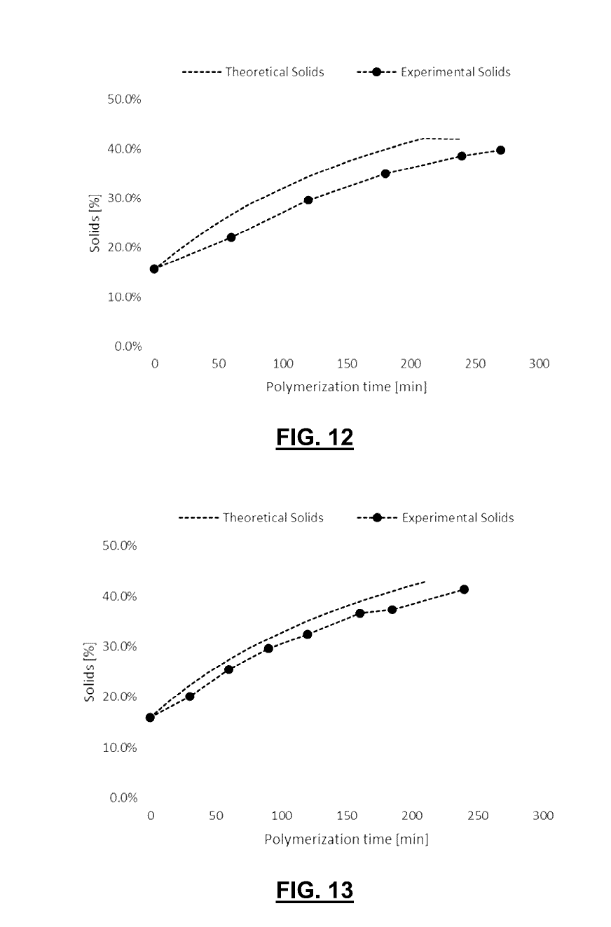

The conversion-solids curve (FIG. 12) demonstrates that the emulsion polymerization proceeded under starved-fed conditions.

Thus both Examples 13 and 14 demonstrate that the maleated APG modified starch nanoparticles help to speed up the polymerization reaction in the initial stage of the process just as the starch nanoparticles. Without intending to be limited or bound by theory, this demonstrates that the maleated APG modified starch nanoparticles not only act as a seed particle and active comonomer in the polymerization, but also unexpectedly and beneficially as (reactive) surfactant or Pickering stabilizers during the initial stages of the emulsion polymerization.

### Example 16

### Copolymerization of Other Vinyl Functionalized Starch Nanoparticles in an Emulsion Polymerization Process

50 grams of starch nanoparticles produced according to Example 10 by functionalizing with maleic anhydride (MAn) were dispersed in water (approx. 16 w/wt %) and heated to 60 degrees Celsius. The dispersion was then purged with nitrogen for 30 minutes to remove dissolved oxygen. Subsequently, 8 mL of an aqueous ammonium persulfate solution (10 w/v %) was added to start the polymerization.

A monomer pre-emulsion, consisting of 62 grams distilled deionized water, 11.7 grams Aerosol™ EF-800 (Cytec Industries), 149 grams methyl methacrylate, 77 grams butyl acrylate was fed continuously for 210 minutes at a rate of 1.14 g/min. Simultaneously, 15 mL of an aqueous ammonium persulfate solution (10 w/v %) was added continuously for 240 minutes at a rate of 0.06 mL/min. Post-polymerization was carried out for 30 minutes and the latex cooled to 25 degrees Celsius, filtered to remove any minor fraction of coagulum formed, and drained from the reactor.

The resulting latex had a solids content of 41.3 w/w %, a pH of 6-7 and a Brookfield viscosity of 370 cP at 25 degrees Celsius. The biocontent of the latex equals approximately 20 w/w %. The whiteness offset of the latex is 10.5%. The dispersion was followed with time and remained stable.

The conversion-solids curve (FIG. 13) demonstrates that the emulsion polymerization proceeded under starved-fed conditions.

### Example 17

### Copolymerization of Other Vinyl Functionalized Starch Nanoparticles in an Emulsion Polymerization Process

50 grams of starch nanoparticles produced according to Example 10 by functionalizing with glycidyl methacrylate were dispersed in water (approx. 16 w/w %) and heated to 60 degrees Celsius. The dispersion was then purged with nitrogen for 30 minutes to remove dissolved oxygen. Subsequently, 2.4 grams itaconic acid and 8 mL of an aqueous ammonium persulfate solution (10 w/v %) were added to start the polymerization.

A monomer pre-emulsion, consisting of 52 grams distilled deionized water, 9.9 grams Aerosol™ EF-800 (Cytec Industries), 132 grams methyl methacrylate, 69 grams butyl acrylate was fed continuously for 100 minutes at a rate of 1.14 g/min. Simultaneously, 7.5 mL of an aqueous ammonium persulfate solution (10 w/v %) was added continuously for 120 minutes at a rate of 0.06 mL/min. Post-polymerization was carried out for 30 minutes and the latex cooled to 25 degrees Celsius, filtered to remove any minor fraction of coagulum formed, and drained from the reactor.

The resulting latex had a solids content of 32.1 w/w %, a pH of 4-5 and a Brookfield viscosity of 221 cP at 25 degrees Celsius. The biocontent of the latex equals approximately 35 w/w %. The whiteness offset of the latex is 10.9%.

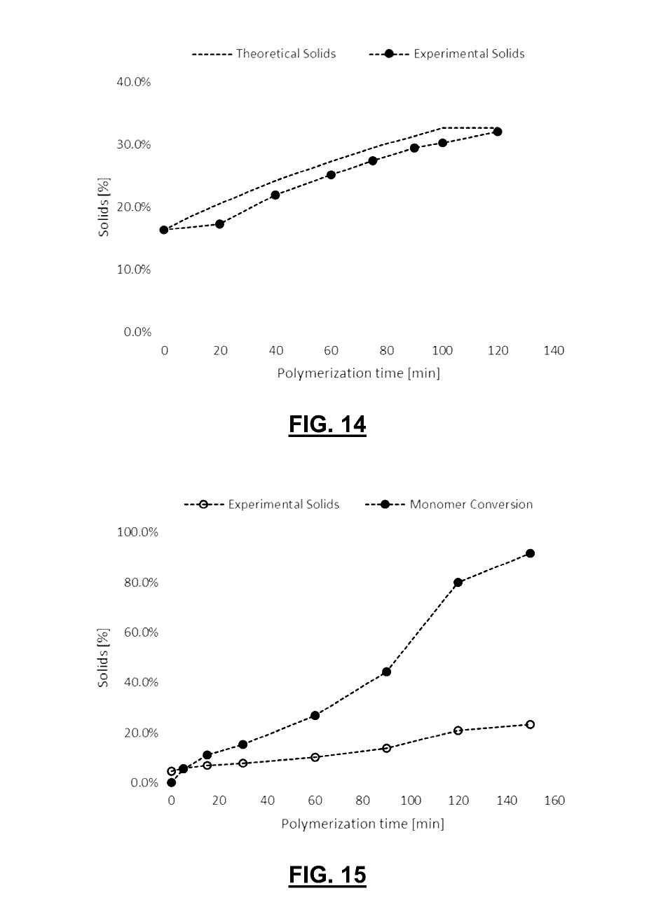

The conversion-solids curve (FIG. 14) demonstrates that the emulsion polymerization proceeded under starved-fed conditions.

Comparison of the results in FIGS. 8 to 12 with those in FIGS. 13 and 14 demonstrates that the vinyl modified starch nanoparticles help to accelerate the polymerization reaction in the initial stage of the process just as the unmodified and the maleated APG modified starch nanoparticles.

### Example 18

### Copolymerization of Starch Nanoparticles in a Cerium Initiated Emulsion Polymerization Process

Cerium can create a free radical onto starch polymer, which can be used as a grafting site to initiate copolymerization with vinyl monomers from starch and other polysaccharides.

23.5 grams of starch nanoparticles (EcoSphere™ 2202 produced by EcoSynthetix Inc.) were dispersed in water (6.3 w/w %) and heated to 50 degrees Celsius. 1.2 grams Aerosol™ EF-800 (Cytec Industries) and 0.4 grams sodium carbonate were added to the starch nanoparticle dispersion.

The monomers, 62 grams methyl methacrylate, 32 grams butyl acrylate, and 1.2 grams acrylic acid were added and the emulsion was then purged with nitrogen for 30 minutes to remove dissolved oxygen. Subsequently, 5 mL of an aqueous cerium ammonium nitrate solution (20 w/v %) was added to start the polymerization.

Post-polymerization was carried out for 30 minutes and the latex cooled to 25 degrees Celsius, filtered to remove any minor fraction of coagulum formed, and drained from the reactor.

The resulting latex had a solids content of 24.4 w/w %, a pH of 3-4 and a Brookfield viscosity of 44 cP at 25 degrees Celsius. The biocontent of the latex equals approximately 20 w/w %. The whiteness offset of the latex is 9.3%. The dispersion was followed with time and remained stable.

The conversion-solids curve (FIG. 15) demonstrates that nearly complete monomer conversion is reached within 150 min.

We claim:

1. A method of making a latex comprising the steps,
producing biopolymer nanoparticles; and,
polymerizing a latex forming vinyl monomer in a free radical polymerization reaction in the presence of the biopolymer nanoparticles.

2. The method of claim 1 comprising co-polymerizing the biopolymer nanoparticles and the latex forming vinyl monomer.

3. The method of claim 2 further comprising reacting the biopolymer nanoparticles with a functionalizing agent before or during the polymerization reaction.

4. The method of claim 3 wherein the biopolymer nanoparticles are functionalized with double bonds or free radicals.

5. The method of claim 3 comprising reacting the biopolymer nanoparticles with another vinyl monomer before the polymerization reaction.

6. The method of claim 5 wherein the biopolymer nanoparticles are reacted with the vinyl monomer by way of reactive extrusion.

7. The method of claim 3 wherein the biopolymer nanoparticles are reacted with a grafting agent during the polymerization reaction.

8. The method of claim 7 wherein the grafting agent comprises Cerium (IV) ions.

9. The method of claim 1 wherein the polymerization reaction is a starve fed emulsion polymerization reaction.

10. The method of claim 1 wherein 50% or more of the biopolymer nanoparticles is made up of crosslinked starch with a molecular weight of at least 100,000 Da.

11. The method of claim 1 wherein the biopolymer nanoparticles are made by extruding one or more biopolymers in the presence of a crosslinker.

12. The method of claim 1 comprising the step of reacting the biopolymer nanoparticles with a functionalizing agent before the polymerization reaction.

13. The method of claim 12 wherein the functionalizing agent comprises one or more of glycidyl methacrylate, methacrylic anhydride, maleic anhydride, itaconic anhydride, allyl chloride, and hydroxyethyl acrylate and other functional monomers that can be reacted with epoxies, isocyanates and other multifunctional hydroxyl-reactive compounds or crosslinkers, and mixtures thereof.

14. The method of claim 12 wherein the functionalizing agent comprises one or more of glycidyl methacrylate, methacrylic anhydride, maleic anhydride, itaconic anhydride, allyl chloride, hydroxyethyl acrylate or an isocyanate.

15. A nanoparticle comprising,
at least a first compound and a second compound, or a reaction product of the first and second compounds, wherein,
at least the first compound is in part or entirely bio-based, and
the second compound is a vinyl monomer.

16. The nanoparticle of claim 15 wherein the vinyl monomer comprises one or more of glycidyl methacrylate, methacrylic anhydride, maleic anhydride, itaconic anhydride, allyl chloride, and hydroxyethyl acrylate and other functional monomers that can be reacted with epoxies, isocyanates and other multifunctional hydroxyl-reactive compounds or crosslinkers, and mixtures thereof.

17. The nanoparticle of claim 15 wherein the vinyl monomer comprises one or more of glycidyl methacrylate, methacrylic anhydride, maleic anhydride, itaconic anhydride, allyl chloride, hydroxyethyl acrylate or an isocyanate.

18. The nanoparticle of claim 15 wherein the first and second compounds are reacted after producing a nanoparticle of the first compound.

19. The nanoparticle of claim 15 wherein the first compound is starch having a molecular weight of at least 100,000 Da.

20. The nanoparticle of claim 15 wherein the second compound comprises APG or maleated APG.
